(19) United States
(12) Patent Application Publication
(10) Pub. No.: US 2025/0286936 A1
(43) Pub. Date: Sep. 11, 2025

(54) INFORMATION PROCESSING TERMINAL AND DATA MANAGEMENT SYSTEM

(71) Applicant: DENSO WAVE INCORPORATED, Chita-gun (JP)

(72) Inventors: Kentaro MISHINA, Chita-gun (JP); Takeshi MIWA, Chita-gun (JP); Toshio MORIMOTO, Chita-gun (JP); Kazumi KAMBE, Chita-gun (JP)

(73) Assignee: DENSO WAVE INCORPORATED, Chita-gun (JP)

(21) Appl. No.: 19/072,229

(22) Filed: Mar. 6, 2025

(30) Foreign Application Priority Data
Mar. 11, 2024 (JP) 2024-037432

(51) Int. Cl. H04L 67/60; H04L 67/1095

(52) U.S. Cl. CPC H04L 67/60; H04L 67/1095

(57) ABSTRACT

An information processing terminal includes: a memory; a processor loading programs from the memory to execute the programs; and a transceiver sending/receiving a message to/from a server. The memory stores: a program of a predetermined application (APP); a program of an operating system managing the APP; data obtained by execution of the APP; a message queue; and a program of first and second processing units. The first processing unit captures a data update event generated by executing the APP and causes the message queue to store a message associated with the data update event. The second processing unit performs a data synchronization with the server by sending the message associated with the data update event stored in the message queue to the server when the information processing terminal is able to communicate with the server, and the APP runs independently of the first and second processing units.

### CROSS-REFERENCE TO RELATED APPLICATION

This application is based on and claims the benefit of priority from earlier Japanese Patent Application No. 2024-37432 filed Mar. 11, 2024, the description of which is incorporated herein by reference.

### BACKGROUND

### 1. Technical Field of the Invention

The present disclosure relates to an information processing terminal and a data management system.

### 2. Related Art

In order to facilitate the building of an online application using an information processing terminal equipped with no general-purpose operating system (in particular, an online application whose main purpose is data sharing between the information processing terminal and a server), a large number of development frameworks for online applications have been provided. As for such a development framework, a center apparatus may be installed between the server and the information processing terminal and the center apparatus coverts screen description information (for example, HTML (hyper-text markup language) information), which is an example of a result of the execution of a web application that runs on the server, to a command interpretable by the information processing terminal. This makes it possible to cause an application cooperative with the server to run in the information processing terminal whose computer resources (for example, the performance of a processor and the capacity of a memory) are scarce. Such a technology has been designed as a software execution system (for example, JP 4707302 B2).

In the software execution system, a center-side apparatus converts screen description information, which defines an operation guide element and an operation condition to be displayed on a screen of a terminal device, to an instruction for the terminal device and sends the instruction to the terminal device. The terminal device performs processing specified by the center-side apparatus, such as the reception of the input of a user instruction operation, in accordance with the instruction received from the center-side apparatus.

### SUMMARY

However, a technology such as the above-described software execution system is based on the premise that a terminal device is always able to connect to a server. Thus, if the terminal device enters an uncommunicable state where the terminal device is unable to connect to the server, it is impossible to continue running of the application. In particular, as for an application intended to be used in an environment such as a factory or a warehouse where it is difficult to fully provide radio waves for wireless communication inside, the above-described uncommunicable state is likely to occur. Therefore, it is difficult to continue running of the application.

The present disclosure is intended to solve the above-described problem and an object thereof is to provide an information processing terminal enabling an application cooperative with the server to continuously run even in a state where a connection to a server is not possible.

An information processing terminal according to an aspect of the present disclosure includes:
a memory;
a processor configured to load programs from the memory to execute the programs; and
a transceiver configured to send a message to a server and receive a message from the server, in which
the memory is configured to store:
a program of a predetermined application;
a program of an operating system configured to manage the predetermined application;
data obtained by execution of the predetermined application;
a message queue; and
a program of a first processing unit and a second processing unit,
the predetermined application, the operating system, the first processing unit, and the second processing unit are implemented by the processor executing the programs stored in the memory,
the first processing unit is configured to capture a data update event generated by executing the predetermined application and cause the message queue to store a message associated with the data update event,
the second processing unit is configured to perform a data synchronization with the server by sending the message associated with the data update event stored in the message queue to the server when the information processing terminal is able to communicate with the server, and
the predetermined application is configured to run independently of the first processing unit and the second processing unit.

### BRIEF DESCRIPTION OF THE DRAWINGS

In the accompanying drawings:

FIG. 1 is a diagram for explaining a data management system including an information processing terminal according to a first embodiment;

FIG. 2A is a block diagram schematically exemplifying a hardware configuration of the information processing terminal illustrated in FIG. 1;

FIG. 2B is a block diagram schematically exemplifying a wireless tag processing unit illustrated in FIG. 2A;

FIG. 2C is a block diagram schematically exemplifying an information code reading unit illustrated in FIG. 2A;

FIG. 3 is a block diagram illustrating a functional configuration related to data acquiring and sending/receiving of the information processing terminal illustrated in FIG. 1;

FIG. 4A is an explanatory diagram exemplifying an already-read list corresponding to a theoretical stock list that is to be received from a server at the start of the running of an application;

FIG. 4B is an explanatory diagram exemplifying an already-read list updated from the already-read list illustrated in FIG. 4A;

FIG. 4C is an explanatory diagram exemplifying a message associated with a data update event captured at the time of an update of the already-read list from FIG. 4A to FIG. 4B;

FIG. 5 is a flowchart schematically illustrating an execution schedule of an application and an operating system in the first embodiment;

FIG. 6 is a flowchart illustrating a specific example of the execution schedule illustrated in FIG. 5;

FIG. 7 is a sequence diagram for explaining a flow of data acquiring and sending/receiving of each information processing terminal and data delivery through a relay server in a second embodiment;

FIG. 8 is a sequence diagram for explaining a flow of data acquiring and sending/receiving of each information processing terminal and data delivery through a relay server in a modification example of the second embodiment;

FIG. 9 is a sequence diagram for explaining a flow of data acquiring and sending/receiving of each information processing terminal and data delivery through a relay server in a fifth embodiment;

FIG. 10 is a sequence diagram for explaining a flow of data output, data acquiring, and sending/receiving of each information processing terminal and data delivery through a relay server in a sixth embodiment;

FIG. 11 is a diagram for explaining a schematic configuration of a management system including an information processing terminal and a server according to a seventh embodiment; FIG. 12 is a flowchart exemplifying a flow of processing that is to be performed when a predetermined application is executed in the information processing terminal illustrated in FIG. 11;

FIG. 13A is a diagram for explaining a first screen template;

FIG. 13B is a diagram for explaining a second screen template;

FIG. 14 is a diagram for explaining a schematic configuration of a management system including an information processing terminal and a server according to a first modification example of the seventh embodiment;

FIG. 15 is an explanatory diagram exemplifying a screen template and individual update regions according to the first modification example of the seventh embodiment;

FIG. 16 is a diagram for explaining a schematic configuration of a management system including an information processing terminal and a server according to a second modification example of the seventh embodiment;

FIG. 17 is a flowchart exemplifying a flow of processing that is to be performed when a predetermined application is executed in the information processing terminal illustrated in FIG. 16;

FIG. 18 is a diagram for explaining a schematic configuration of a management system including an information processing terminal and a server according to a third modification example of the seventh embodiment;

FIG. 19 is a flowchart exemplifying a flow of processing that is to be performed when a predetermined application is executed in the information processing terminal illustrated in FIG. 18;

FIG. 20 is a diagram for explaining a specific example of the third modification example of the seventh embodiment;

FIG. 21A is an explanatory diagram for explaining a schematic configuration of a management system including an information processing terminal and a server according to a fourth modification example of the seventh embodiment, illustrating processing in a case where network communication is possible;

FIG. 21B is an explanatory diagram for explaining the schematic configuration of the management system including the information processing terminal and the server according to the fourth modification example of the seventh embodiment, illustrating processing in a case where the network communication is impossible;

FIG. 22 is a flowchart exemplifying a flow of processing that is to be performed when a predetermined application is executed in the information processing terminals illustrated in FIG. 21A and FIG. 21B;

FIG. 23A is a diagram for explaining a specific example of the fourth modification example of the seventh embodiment, exemplifying a case where synchronization processing is not to be performed; and

FIG. 23B is a diagram for explaining a specific example of the fourth modification example of the seventh embodiment, exemplifying a case where the synchronization processing is to be performed.

### DETAILED DESCRIPTION OF THE PREFERRED EMBODIMENTS

### First Embodiment

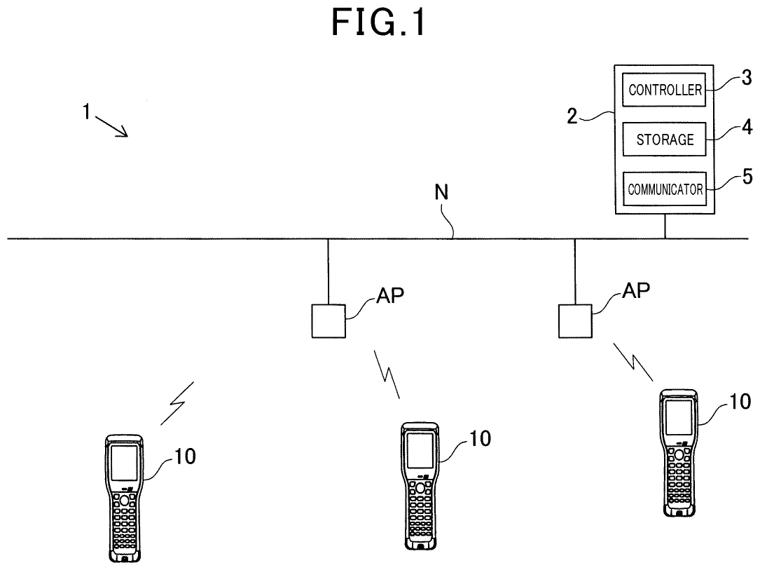

Hereinafter, an information processing terminal and a data management system according to a first embodiment of the present disclosure will be described with reference to the drawings. As illustrated in FIG. 1, a data management system 1 according to the present embodiment includes a plurality of information processing terminals 10 and a server 2 for managing data acquired by each of the plurality of information processing terminals 10.

The server 2 according to the present embodiment is, for example, a server apparatus that functions as an MQTT message broker that performs data delivery according to the MQTT protocol. The server 2 communicates with the information processing terminal 10 connected to a predetermined network N, such as an in-house LAN (local area network), via an access point AP disposed in a predetermined management area. The server 2 thereby performs the sending/receiving of messages between the server 2 and each of the plurality of information processing terminals 10, the management of data acquired from the plurality of information processing terminals 10, and the like.

As illustrated in FIG. 1, the server 2 mainly includes a storage 4, a communicator 5, and a controller 3 that collectively controls the storage 4 and the communicator 5. The controller 3 may be implemented by a microcomputer. The microcomputer may include a CPU (central processing unit), a system bus, an input/output interface, and the like. The controller 3 and the storage 4 function as an information processing apparatus. The storage 4 may be a known semiconductor memory, for example, a non-volatile memory such as a ROM (read-only memory) or a volatile memory such as a RAM (random-access memory). The storage 4 stores in advance predetermined application program for performing data delivery processing based on the MQTT protocol, which are usable by the controller 3. The communicator 5 is to be controlled by the controller 3 to communicate with the plurality of information processing terminals 10 connected to the predetermined network N such as an in-house LAN or the Internet.

The information processing terminal 10 according to the present embodiment may be a portable information reading device that is to be carried by a user and used in a variety of places. The information processing terminal 10 has a function to read and write information stored in a wireless tag T, such as an RF (radio frequency) tag, through the medium of a radio wave sent/received using an antenna. Further, the information processing terminal 10 have a function as an information code reader to optically read an information code such as a barcode or a two-dimensional code. That is to say, the information processing terminal 10 can read information in two ways.

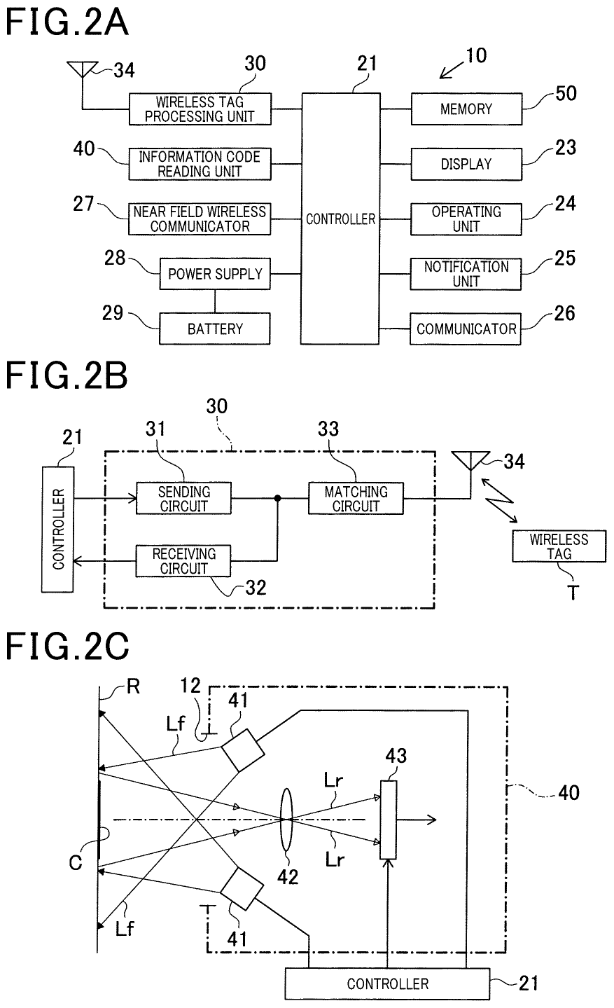

The information processing terminals 10 each mainly include a controller 21, a display 23, an operating unit 24, a notification unit 25, a communicator 26, a near field wireless communicator 27, a power supply 28, a battery 29, and a memory 50 as illustrated in FIG. 2A. The controller 21 is responsible for overall control. The memory 50 is a semiconductor memory or the like. The display 23 displays content in accordance with the control of the controller 21. The operating unit 24 outputs an operation signal corresponding to an input operation to the controller 21. The notification unit 25 is implemented by a light emitter, a speaker, a buzzer, or the like. A light-emission state of the light emitter, a sound-output state of the speaker, a sound-output state of sounding of the buzzer, or the like is to be controlled by the controller 21.

The communicator 26 communicates with external equipment such as the server 2. The communicator 26 may be, for example, a Wi-Fi module. The near field wireless communicator 27 performs a near field wireless communication with another information processing terminal 10 or the like. The power supply 28 supplies an electric power from the battery 29 to a variety of electrical components. The controller 21 according to the present embodiment may be, for example, a single processor that loads software (i.e., programs) from the memory 50 to execute the software. As described later, the controller 21 switches processing of an application 51 (i.e., an app 51) and processing of an operating system 52 (i.e., an OS 52) appropriately and performs processing of them instead of performing processing of them at the same time.

The information processing terminal 10 also include a wireless tag processing unit 30 and an information code reading unit 40. The wireless tag processing unit 30 reads information from the wireless tag T and writes information into the wireless tag T. The information code reading unit 40 optically reads an information code.

The wireless tag processing unit 30, as a wireless communicator, wirelessly communicates with a plurality of wireless tags T by using a predetermined modulation scheme controlled by the controller 21. The wireless tag processing unit 30 works in cooperation with an antenna 34 and the controller 21 to communicate with the wireless tag T using electromagnetic waves. The wireless tag processing unit 30 thereby reads data stored in the wireless tag T and writes data into the wireless tag T. The wireless tag processing unit 30 may be a circuit that performs the transmission of a signal by a known communication scheme. The wireless tag processing unit 30 includes a sending circuit 31, a receiving circuit 32, a matching circuit 33, and the like as schematically illustrated in FIG. 2B.

The information code reading unit 40 optically reads an information code. The information code reading unit 40 includes a light-reception sensor 43 including a CCD (charge coupled device) area sensor, an imaging lens 42, an illuminator 41 including a plurality of LEDs (light emitting diodes) and a lens, and the like as illustrated in FIG. 2C. The information code reading unit 40 works in cooperation with the controller 21 to read an information code C (for example, a barcode or a two-dimensional code) attached to a reading target R.

In a case where the information code reading unit 40 performs reading, the illuminator 41 first outputs an illumination light Lf in response to receiving an instruction from the controller 21. The illumination light Lf is irradiated through a reading aperture 12 to the reading target R. The illumination light Lf is then reflected by the information code C and a reflected light Lr is taken inside through the reading aperture 12. The reflected light Lr is received by the light-reception sensor 43 through the imaging lens 42. The imaging lens 42, which is disposed between the reading aperture 12 and the light-reception sensor 43, causes an image of the information code C to be formed on the light-reception sensor 43. The light-reception sensor 43 outputs a light-receiving signal corresponding to the image of the information code C. The light-receiving signal outputted from the light-reception sensor 43 is stored as image data in the memory 50 (see FIG. 2A). The image data is to be used for decoding processing for acquiring information contained in the information code C. It should be noted that although the information code reading unit 40 is provided with an amplifier circuit that amplifies a signal from the light-reception sensor 43, an AD (analog-digital) converter circuit that converts the amplified signal to a digital signal, and the like, the illustration of these circuits is omitted.

Hereinafter, a framework for an application to be used in the information processing terminal 10 according to the present embodiment will be described. It is assumed that an inventory work of articles is to be performed using the plurality of information processing terminals 10 on the basis of, for example, a reading result (i.e., an acquired result) of a tag ID (a tag identifier) (i.e., a key) recorded in a UII area of a wireless tag T attached to each of the articles displayed in a store. In this case, the server 2 manages an already-read list in accordance with a tag ID received from each of the information processing terminals 10. The already-read list is to be sequentially updated. This enables the server 2 to know a progress of the inventory work (i.e., an overall status of data acquisition using each of the information processing terminals 10). The information processing terminal 10 is then able to make an inquiry to the server 2 about whether the read tag ID is already read by another information processing terminal 10. For example, the information processing terminal 10 may make an inquiry to the server 2 during processing to read the wireless tag T. Only in a case where the information processing terminal 10 is, as a result of the inquiry, determined as having read a tag ID that has not yet been read by another information processing terminal 10 yet, the information processing terminal 10 causes a predetermined buzzer to sound. This enables a worker to distinguish between an unread wireless tag T and an already-read wireless tag T and efficiently perform the inventory work.

However, the information processing terminal 10 may be unable to communicate with the server 2 as moving to an area where a communication environment is poor. Here, the already-read list is managed by the server 2. Since the information processing terminal 10 is unable to make an inquiry to the server 2, it is not possible to determine whether an unread wireless tag T has been read. As a result, the worker may be unable to continue the inventory work. A work that may be accompanied by such a problem is not limited to the inventory work. A similar problem may occur during any work in which data acquired by reading from the wireless tag T or the information code C using each of the information processing terminals 10 is to be centrally managed by the server 2.

Accordingly, a program of a predetermined application (i.e., the app 51) is installed on the information processing terminal 10 according to the present embodiment. The app 51 is an application for performing the inventory work (i.e., a data acquisition work) using the plurality of information processing terminals 10 even in a case where a communication with the server 2 is impossible. The controller 21 functions as a computing unit to execute the program of the app 51.

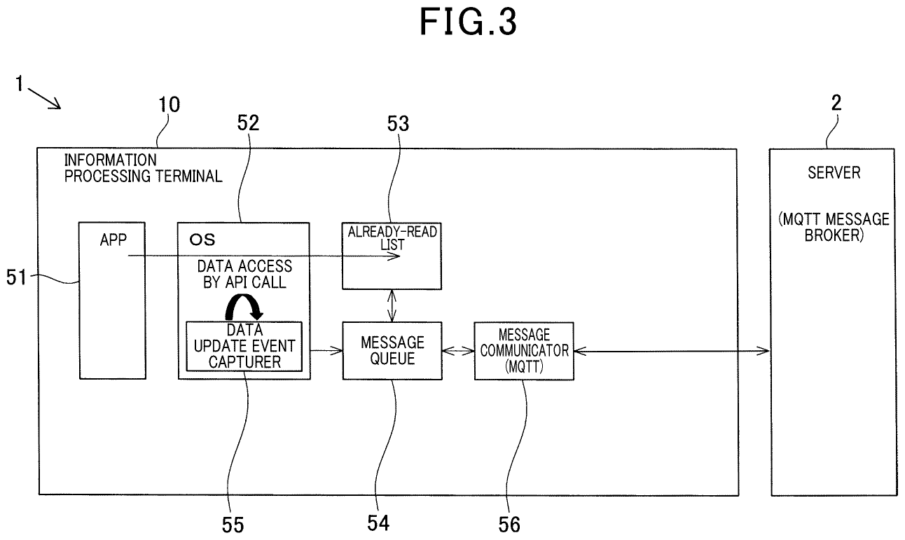

In the app 51, data processing such as acquiring, storing, and the like of data is to be desynchronized with processing to communicate with the server 2 as described later. As the app 51 is executed, processing for updating an already-read list 53, which is stored in the memory 50, in accordance with the read tag ID or the like is performed. Then, the program of the app 51, a program of the operating system 52 (i.e., the OS 52) that manages the app 51, and the already-read list 53 are stored in the memory 50 as illustrated in FIG. 3. The memory 50 stores a message queue 54, a program of a data update event capturer 55 (i.e., a first processing unit), and a program of a message communicator 56 (i.e., a second processing unit).

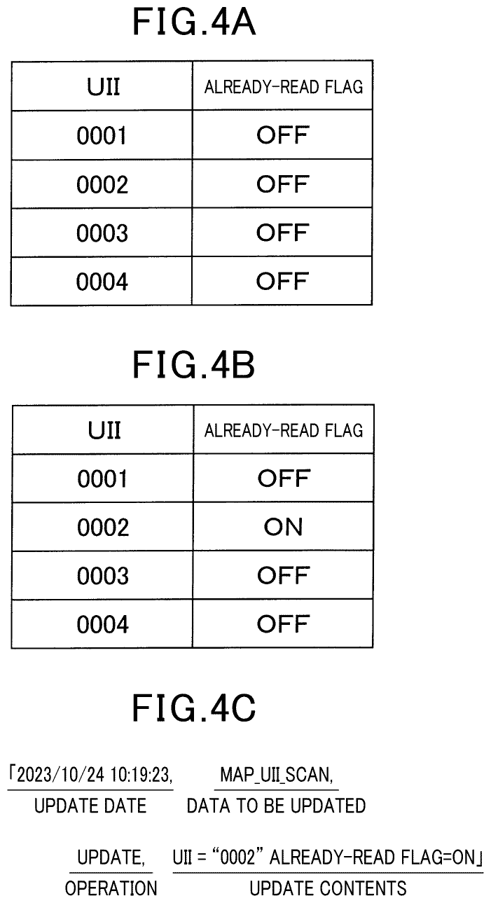

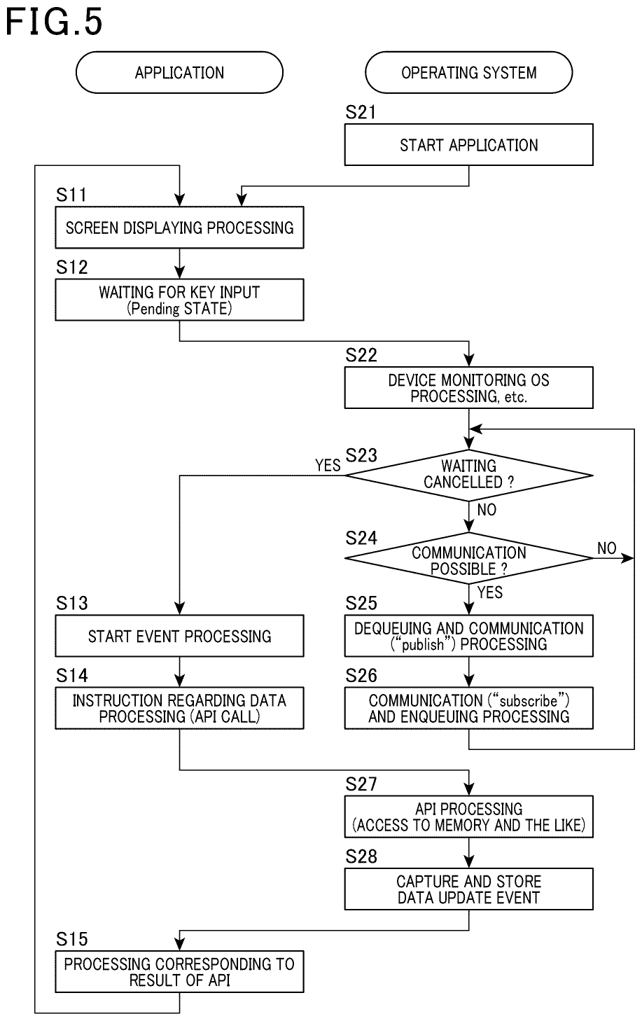

The already-read list 53 is to be managed by the OS 52. A data structure of the already-read list 53 may be a map array (i.e., an array of a pair of key and value). The already-read list 53 is a list for determining whether a tag ID is unread. The already-read list 53 is to be received, as a list (i.e., a theorical stock list) of tag IDs to be read for the inventory work, from the server 2 at the start of the app 51. For a data update of the already-read list 53, an already-read flag is set to ON with respect to a tag ID read from an UII area of an RF tag. For example, a theorical stock list in which already-read flags are set to OFF for all of four tag IDs may be received from the server 2 at the start of the app 51 as exemplified in FIG. 4A. In response to a tag ID 0002 being read, the already-read flag for the tag ID 0002 is set to ON as exemplified in FIG. 4B. The already-read list 53 is to be updated in this manner. It should be noted that the updated already-read list 53 may correspond to an example of data obtained by the execution of the app 51.

The message queue 54 is to be managed by the OS 52. The message queue 54 is to be used to desynchronize the data processing such as the acquiring, storing, and the like of data and the processing to communicate with the server 2. For example, the message queue 54 may be a FIFO (first in first out) message queue. The message queue 54 temporarily stores a message associated with a captured data update event by the data update event capturer 55 as described later.

The data update event capturer 55 is to be managed by the OS 52. The data update event capturer 55 captures, as a data update event, a data access for data update and causes the message queue 54 to store a message associated with the data update event. The data access for data update is to be performed, for example, when the app 51 having acquired the data updates the already-read list 53 by an API (Application Programming Interface) call. For example, in a case where data is to be updated from FIG. 4A to FIG. 4B, data update information such as an update date, data to be updated, an operation, or update contents may be captured as a data update event by the data update event capturer 55 as exemplified in FIG. 4C. An update message associated with the captured data update event is temporarily stored in the message queue 54. That is to say, the message associated with the data update event contains update information regarding the data.

The message communicator 56 is to be managed by the OS 52. The message communicator 56 sends the message associated with the data update event stored in the message queue 54 and receives a message sent from the server 2 while a communication with the server 2 is possible. The message communicator 56 thereby performs a data synchronization with the server 2.

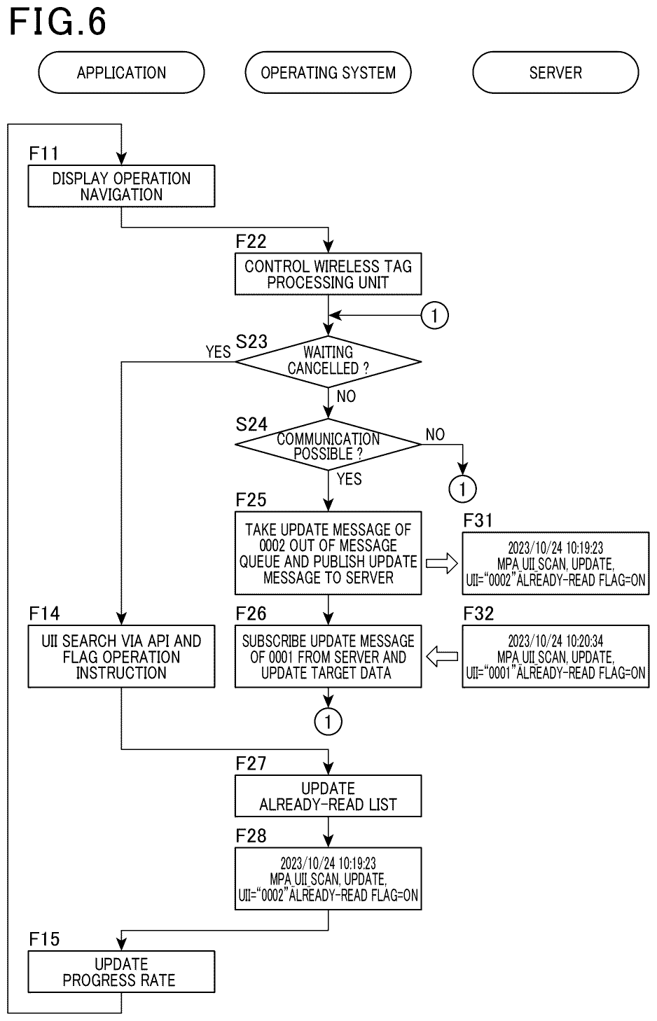

Next, an execution schedule of the app 51 and the OS 52 when the above-described app 51 is started in the information processing terminal 10 and the inventory work is performed will be described in detail with reference to flowcharts in FIG. 5 and FIG. 6.

By a predetermined operation on the operating unit 24 by the worker, the app 51 is started under the management of the OS 52 (S21). The app 51 performs screen displaying processing (S11). During the screen displaying process, for example, an operation navigation or the like regarding an instruction to read the wireless tag T and an operation may be displayed on a screen of the display 23 (F11). The app 51 is put into a waiting state (i.e., a Pending state) to wait for the worker to perform an input operation such as an operation of an operation key (S12).

In the waiting state of the app 51, a control transfer to the OS 52 is performed and OS processing to monitor the running or the like of a variety of devices of the information processing terminal 10 is performed (S22). Specifically, the OS 52 is put into a state of it being able to control the wireless tag processing unit 30 or the like (F22).

Then, in response to an operation on the operating unit 24 by the worker for reading the wireless tag T, the waiting state is cancelled (Yes in S23). A control transfer to the app 51 is performed and event processing for reading the wireless tag T using the wireless tag processing unit 30 is started (S13).

In response to a tag ID being read from each of the wireless tags T in a readable region through the above-described event process, the app 51 issues, to the OS 52, an instruction (i.e., an API call) regarding data processing for updating the already-read list 53 for the read tag ID (S14). For example, in a case where the tag ID 0002 has been read, the tag ID 0002 may be searched in the UII via the API by a map array operation. In a case where the already-read flag for the tag ID 0002 is OFF, an instruction to perform a flag operation to set the already-read flag for the tag ID 0002 to ON is issued to the OS 52 (F14). A control transfer to the OS 52 is thereby performed.

The OS 52 issued with the instruction accesses the already-read list 53 and performs API processing for updating the already-read flag for the read tag ID to ON (S27). Specifically, in response to the instruction being issued to perform the flag operation to set the already-read flag for the tag ID 0002 to ON as described above, a map array operation corresponding to the instruction is performed to update the already-read list 53 (F27).

The OS 52 causes the data update event capturer 55 to capture, as a data update event, the data access for the above-described data update and causes the message queue 54 to store a message associated with the data update event (S28). Specifically, in a case where the already-read list 53 is to be updated as described above, an update message associated with the data update event exemplified in FIG. 4C is stored in the message queue 54 (F28).

A control transfer to the app 51 is performed and processing corresponding to a result of the API such as displaying processing and notification processing depending on the reading result is performed (S15). As a result, a work progress rate is updated (F15). Then, the processing returns to S11.

In contrast, when the app 51 is in the waiting state (No in S23) and the information processing terminal 10 enters a state in which the information processing terminal 10 is able to wirelessly communicate with the server 2 via the communicator 26 (Yes in S24), the OS 52 performs dequeuing and communication (i.e., “publish”) processing (S25). In this process, the message communicator 56 sends the message associated with the data update event, which is stored in the message queue 54 as described above, to the server 2 via the communicator 26 along with a delivery destination (for example, another terminal). For example, in a case where an update message regarding the tag ID 0002 exemplified in FIG. 4C is stored in the message queue 54, the update message may be taken out of the message queue 54 and the update message is sent (i.e., “publish”) to the server 2 along with the delivery destination of the update message (for example, another terminal) (F25).

Subsequently, communication (i.e., “subscribe”) and enqueuing processing is performed (S26). In this process, a message accumulated in the server 2 and whose delivery destination is the information processing terminal 10 is received from the server 2 via the communicator 26 by the message communicator 56. The already-read list 53 is updated in accordance with the received message. For example, as for the already-read list 53 in FIG. 4B, a message (including an update date, data to be updated, an operation, or update contents) associated with a data update event regarding a tag ID 0001 may be received. Accordingly, an already-read flag for the tag ID 0001 is set to ON to update the already-read list 53.

The server 2 which received the update message delivers the received update message to, out of the other information processing terminals 10 set as the delivery destinations of the update message, the information processing terminal 10 which is able to communicate. The update message to the information processing terminal 10 which is unable to communicate is to be delivered when the information processing terminal 10 becomes able to communicate. That is to say, the server 2 performs a temporary storing process. For example, the server 2 may receive an update message associated with the tag ID 0002 as described above (F31). The server 2 delivers the received update message to the information processing terminal 10 which is able to communicate. The server 2 temporarily stores the update message at the information processing terminal 10 which is unable to communicate. Moreover, for example, the server 2 may receive an update message associated with the tag ID 0001 whose delivery destination is the information processing terminal 10 having sent the above-described update message (F32). The server 2 delivers the update message to the information processing terminal 10 that is the delivery destination.

That is to say, in a case where the information processing terminal 10 is in a state where a communication with the server 2 is possible, the message communicator 56, which is managed by not the app 51 that performs processing to acquire data but the OS 52 instructed in advance by the app 51, sends the update message to the server 2 via the communicator 26.

As described hereinabove, in the information processing terminal 10 according to the present embodiment, the memory 50 stores the program of the app 51, the program of the OS 52, the already-read list 53, the message queue 54, the program of the data update event capturer 55, and the program of the message communicator 56. The data update event capturer 55 and the message communicator 56 are to be managed by the OS 52. The OS 52 manages the app 51. The data update event capturer 55 captures a data update event for data update by the app 51 and causes the message queue 54 to store a message associated with the data update event. While a communicate with the server 2 is possible, the message communicator 56 performs a data synchronization with the server 2 by sending the message associated with the data update event stored in the message queue 54.

As seen from the above, the processing to cause the message queue 54 to store a message associated with a captured data update event and the processing to perform a data synchronization with the server 2 by sending the message associated with the data update event in the message queue 54 while the communication with the server 2 is possible are to be managed by not the app 51 but the OS 52. Thereby, the processing by the app 51 is desynchronized with the processing to communicate with the server 2. That is to say, these processes are not dependent on each other. In other words, these processes are independent of each other. This enables the app 51 to perform the same logic processing irrespective of a status of the communication with the server 2. Moreover, a description on processing to communicate with the server 2 in the program of the app 51 becomes unnecessary. The running of the application cooperative with the server 2 is thus continuable even though the information processing terminal 10 is in a state where a connection to the server 2 is not possible. The information processing terminal 10 capable of construction of an application unrestricted by the status of communication is implementable even though the amount of usable computer resources is small.

It should be noted that a message associated with a data update event captured by the data update event capturer 55 and stored in the message queue 54 may further contain another information in addition to the information such as an update date, data to be updated, an operation, or update contents. Moreover, the data update event may contain only a part of the above-described information (for example, only an update date and update contents).

### Second Embodiment

Next, an information processing terminal and a data management system according to a second embodiment of the present disclosure will be described with reference to the drawings. The second embodiment is different from the above-described first embodiment mainly in that the memory of each information processing terminal stores not only data acquired by the own information processing terminal but also data acquired by another information processing terminal and received via a relay server. Components substantially the same as those in the first embodiment are denoted by the same reference signs, and the descriptions thereof are omitted.

During an inventory work using a plurality of information processing terminals, reading work areas for two or more of the information processing terminals may overlap. In such a case, data read from the wireless tags T in the overlapping reading work area is to be sent from each of the two or more information processing terminals to the server. As seen from the above, the same data is sent to a server from the individual information processing terminals at the same time depending on a reading work environment, which may lead to a heavy access to the server and an increase in load on the server. As a result, it may become difficult for the individual information processing terminals to access the server. Thereby, the respective working efficiencies thereof may be decreased.

Accordingly, an information processing terminal 100 of a data management system la according to the present embodiment sends, among data (i.e., tag IDs) read from the wireless tags T during the reading processing by the controller 21, data that has not yet been read by another information processing terminal 100. A hardware configuration of the information processing terminal 100 according to the present embodiment is substantially the same as the hardware configuration of the information processing terminal 10 according to the first embodiment. Unlike in the first embodiment, the information processing terminal 100 does not necessarily use a data update event. It should be noted that in the present embodiment, the wireless tag processing unit 30 that reads and acquires the tag ID (i.e., data) from the wireless tag T may correspond to an example of an acquirer. The data acquired by the acquirer is to be stored in the memory 50.

In the present embodiment, instead of the above-described server 2, a master server 2a for managing the data acquired by the information processing terminal 100 and a relay server 2b which is capable of communication with the master server 2a and the information processing terminal 100 are provided. Components of the master server 2a and the relay server 2b are substantially the same as the components of the above-described server 2. Specifically, the controller 3, the storage 4, and the communicator 5 are provided.

The information processing terminal 100 manages data delivered from the relay server 2b as data acquired by the information processing terminal 100. This reduces the sending of the same data to the relay server 2b. That is to say, the controller 21 of the information processing terminal 100 causes the memory 50 to store, among data received from the relay server 2b, data that has not yet been stored in the memory 50 (i.e., a data management process). The controller 21 sends, out of the read data, data that has not yet been stored in the memory 50 to the relay server 2b along with delivery destinations. The delivery destinations of the data are the other information processing terminals 100 and the master server 2a. It should be noted that the controller 21 that performs the above-described data management processing may correspond to an example of a data manager.

The controller 3 of the relay server 2b delivers, via the communicator 5, the data received from the information processing terminal 100 in accordance with the above-described delivery destinations (i.e., a data delivery process). The above-described delivery destinations are to be specified by the information processing terminal 100. It should be noted that the controller 3 and the communicator 5 of the relay server 2b, which perform the above-described data delivery process, may correspond to an example of a data deliverer.

An application (hereinafter, also referred to as server application) is installed in the master server 2a. The server application performs master data management processing for managing master data on the basis of the data acquired by the information processing terminal 100. The server application is to be executed by the controller 3. The master server 2a causes the server application to make an inquiry to the relay server 2b about whether there is data addressed to the master server 2a via the communicator 5. The master server 2a performs the above-described master data management processing on the basis of the data that is received from the relay server 2b and is addressed to the master server 2a.

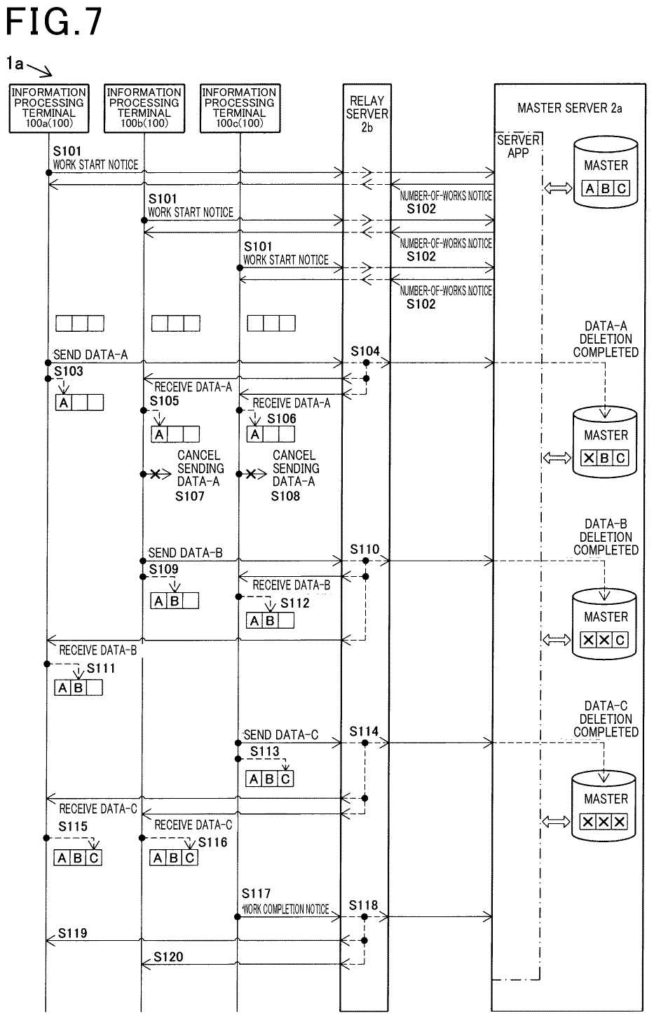

Hereinafter, a flow of the acquiring and sending/receiving of data by the information processing terminal 100 and the data delivery by the relay server 2b will be described in detail with reference to a sequence diagram in FIG. 7. In an example in FIG. 7, data A, data B, and data C are to be read by information processing terminals 100a, 100b, and 100c, respectively.

In the information processing terminals 100a, 100b, 100c, the controller 21 starts the reading processing in response to a predetermined operation on the operating unit 24 by a worker as exemplified in FIG. 7. As starting the reading process, a work start notice is sent to the relay server 2b via the communicator 26 (S101). The relay server 2b relays the work start notice to the master server 2a. The relay server 2b relays (delivers) a number-of-jobs notice from the master server 2a to each of the information processing terminals 100a, 100b, 100c (S102). In a case where the data A, data B, and data C are to be read, the above-described number-of-jobs notice indicates that the number of pieces of data to be read is three. The information processing terminals 100a, 100b, 100c having received the number-of-jobs notice store the number of pieces of data to be read as three. It should be noted that the above-described number-of-jobs notice is not necessarily received via the relay server 2b. The number-of-jobs notice may be received in advance using delivery software or the like in another server.

In the information processing terminal 100a having received the number-of-jobs notice, the data A has been read from the wireless tag T by the wireless tag processing unit 30. In a case where the data A is not stored in the memory 50, the controller 21 notifies that unread data has been read by causing the notification unit 25 to emit light, output a sound, or the like. The controller 21 then performs the data management processing to cause the memory 50 to store the data A. Moreover, data sending processing to send the data A to the relay server 2b via the communicator 26 along with delivery destinations is performed (S103). The delivery destinations of the data A are the other information processing terminals 100b, 100c and the master server 2a. It should be noted that the controller 21 and the communicator 26, which perform the above-described data sending process, may correspond to an example of a data sender.

The relay server 2b delivers the data A received from the information processing terminal 100a to the information processing terminals 100b, 100c and the master server 2a (S104). The master server 2a performs processing to delete, from the master data, an item regarding the data A received from the relay server 2b.

The controller 21 of the information processing terminal 100b performs the data management processing to cause the memory 50 to store the data A in a case where the data A received from the relay server 2b via the communicator 26 is not stored in the memory 50 (S105). Likewise, the controller 21 of the information processing terminal 100c performs the data management processing to cause the memory 50 to store the data A in a case where the data A received from the relay server 2b via the communicator 26 is not stored in the memory 50 (S106). This prevents the data A from being sent from the information processing terminals 100b, 100c to the relay server 2b even though the data A has been read by the information processing terminals 100b, 100c, as the data A is already stored in the memory 50 (S107, S108). For example, the data A not to be sent may be discarded. It should be noted that in a case where the read data is stored in the memory 50 as having been read by another information processing terminal 100, a predetermined notification indicating that the data has already read by the other information processing terminal 100 may be made by light emission, sound output, or the like of the notification unit 25. The controller 21 and the communicator 26, which perform the processing to receive the data delivered from the relay server 2b, may correspond to an example of a data receiver.

Moreover, in the information processing terminal 100b having received the number-of-jobs notice, the data B has been read from the wireless tag T by the wireless tag processing unit 30. In a case where the data B is not stored in the memory 50, the controller 21 notifies that unread data has been read by causing the notification unit 25 to emit light, output a sound, or the like. The controller 21 then performs the data management processing to cause the memory 50 to store the data B. Moreover, data sending processing to send the data B to the relay server 2b via the communicator 26 along with delivery destinations is performed (S109). The delivery destinations of the data B are the other information processing terminals 100a, 100c and the master server 2a.

The relay server 2b delivers the data B received from the information processing terminal 100b to the information processing terminals 100a, 100c and the master server 2a (S110). The master server 2a performs processing to delete, from the master data, an item regarding the data B received from the relay server 2b.

The controller 21 of the information processing terminal 100a performs the data management processing to cause the memory 50 to store the data B in a case where the data B received from the relay server 2b is not stored in the memory 50 (S111). Likewise, the controller 21 of the information processing terminal 100c performs the data management processing to cause the memory 50 to store the data B in a case where the data B received from the relay server 2b is not stored in the memory 50 (S112).

Moreover, in the information processing terminal 100c having received the number-of-jobs notice, the data C has been read from the wireless tag T by the wireless tag processing unit 30. In a case where the data C is not stored in the memory 50, the controller 21 notifies that unread data has been read by causing the notification unit 25 to emit light, output a sound, or the like. The controller 21 then performs the data management processing to cause the memory 50 to store the data C. Moreover, data sending processing to send the data C to the relay server 2b via the communicator 26 along with delivery destinations is performed (S113). The delivery destinations of the data C are the other information processing terminals 100a, 100b and the master server 2a.

The relay server 2b delivers the data C received from the information processing terminal 100c to the information processing terminals 100a, 100b and the master server 2a (S114). The master server 2a performs processing to delete, from the master data, an item regarding the data C received from the relay server 2b.

The controller 21 of the information processing terminal 100a performs the data management processing to cause the memory 50 to store the data C in a case where the data C received from the relay server 2b is not stored in the memory 50 (S115). Likewise, the controller 21 of the information processing terminal 100b performs the data management processing to cause the memory 50 to store the data C in a case where the data C received from the relay server 2b is not stored in the memory 50 (S116).

In the information processing terminal 100c having read the data C, the data A and the data B are already stored in the memory 50. Accordingly, the controller 21 determines that all the data planned to be acquired is stored in the memory 50. That is to say, the information processing terminal 100c is determined to be in a work completion state. In such a case, in the information processing terminal 100c, a work completion notice is sent to the relay server 2b via the communicator 26 along with delivery destinations by the above-described data sending processing (S117). The delivery destinations of the work completion notice are the other information processing terminals 100a, 100b and the master server 2a. Then, it is notified to the worker that all the specified data has been read (i.e., the information processing terminal 100c is in the work completion state) by an indication on the display 23 or the light emission, sound output, or the like of the notification unit 25.

The relay server 2b delivers the work completion notice received from the information processing terminal 100c to the information processing terminals 100a, 100b and the master server 2a (S118).

The information processing terminals 100a, 100b having received the work completion notice know that the information processing terminal 100c is in the work completion state where all the specified data has been read (S119, S120). The work completion state is notified to the worker by an indication on the display 23 or the light emission, sound output, or the like of the notification unit 25. It should be noted that the information processing terminal 100 (in the above-described example, the information processing terminal 100c) which has read the last data (in the above-described example, the data C) may specify only the master server 2a as a delivery destination of the above-described last data without specifying the other information processing terminals 100 in a case where the work completion notice is to be sent and delivered.

As described hereinabove, in the information processing terminal 100 of the data management system la according to the present embodiment, data read by the wireless tag processing unit 30 is to be stored in the memory 50. At least a part of the read data is sent to the relay server 2b through the communicator 26 along with a delivery destination. The delivery destination of the data includes the other information processing terminal 100. The data is to be delivered from the relay server 2b. The controller 21 performs the data management processing for causing the memory 50 to store, among data received by the communicator 26, data that has not yet been stored in the memory 50. In the relay server 2b, the data received from the information processing terminal 100 is delivered to the above-described delivery destination through the data delivery processing performed by the controller 3.

The memory 50 of each of the information processing terminals 100 thus not only records data acquired by the own information processing terminal 100 but also stores data acquired by the other information processing terminal(s) 100 and received via the relay server 2b. This enables each of the plurality of information processing terminals 100 to easily know the overall status of data acquisition using the plurality of information processing terminals 100. As a result, even in a case where the individual information processing terminals 10 separately acquire data, it is possible to reduce duplication of data acquisition. That is to say, an improvement in working efficiency can be achieved.

In particular, among data acquired by the wireless tag processing unit 30 reading from the wireless tag T, data that has not yet been stored in the memory 50 is sent to the relay server 2b.

The relay server 2b is thus unlikely to receive duplicated data. This makes it possible to reduce an increase in the access load to the relay server 2b. It is also possible to reduce a decrease in working efficiency due to the access load.

Moreover, in response to determination that all the data planned to be acquired is stored in the memory 50, the work completion notice is sent to the relay server 2b along with delivery destinations. The delivery destinations of the work completion notice include the other information processing terminal 100.

Thereby, when at least one of the plurality of information processing terminals 100 enter the work completion state, the information processing terminal 100 other than the information processing terminal 100 in the work completion state receives the work completion notice. This allows any of the information processing terminals 100 to promptly know that all the data planned to be acquired have been acquired (i.e., the data acquisition work is completed).

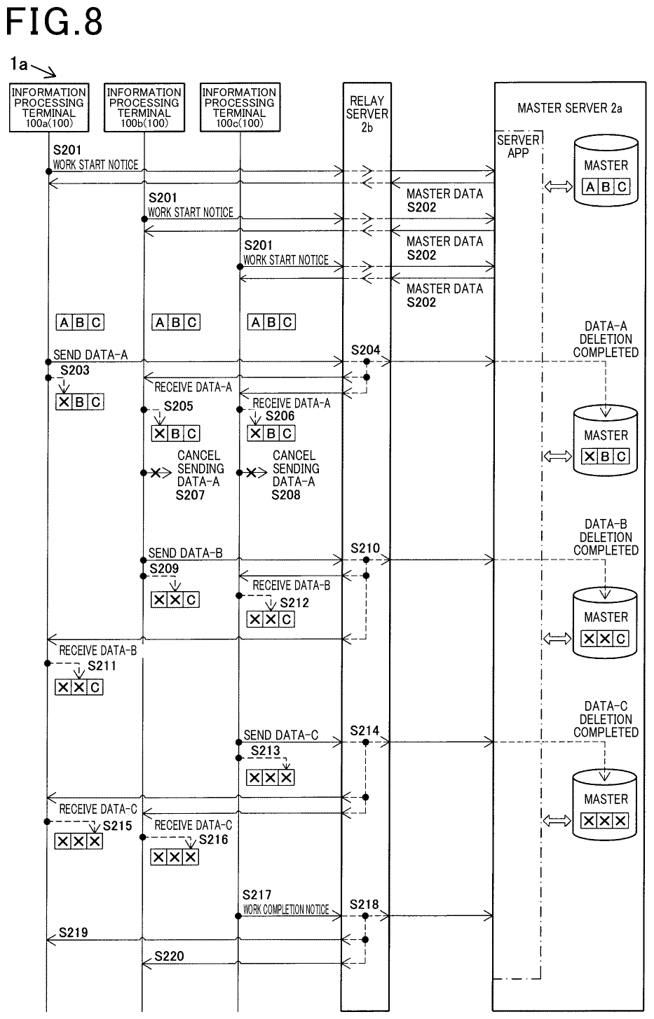

It should be noted that the information processing terminal 100 may receive information indicating data to be read in place of the number-of-jobs notice. For example, after the work start notice is sent (S201), the information processing terminals 100a, 100b, 100c may receive, from the relay server 2b, the master data indicating data to be read (S202) as exemplified in FIG. 8. This allows the information processing terminals 100a, 100b, 100c to know in advance that the reading work is to be completed by reading the data A, the data B, and the data C. It should be noted that the above-described master data is not necessarily received via the relay server 2b. The master data may be received in advance using delivery software or the like in another server.

In this case, in the information processing terminal 100a having read the data A, the master data is updated by deleting the item regarding the data A from the master data stored in the memory 50. The data A is then sent to the relay server 2b (S203). In the information processing terminals 100b, 100c, the data A is received from the relay server 2b (S204). The master data is updated by deleting the item regarding the data A from the master data in the memory 50 (S205 and S206). This update prevents the data A from being sent to the relay server 2b from the information processing terminals 100b, 100c even though the data A has been read by the information processing terminals 100b, 100c, since the item regarding the data A is deleted from the master data stored in the memory 50 (S207 and S208). For example, the data A may be discarded without being sent.

Moreover, in the information processing terminal 100b having read the data B, the master data is updated by deleting the item regarding the data B from the master data stored in the memory 50. The data B is then sent to the relay server 2b (S209). In the information processing terminals 100a, 100c, the data B is received from the relay server 2b (S210). The master data is updated by deleting the item regarding the data B from the master data in the memory 50 (S211 and S212).

Moreover, in the information processing terminal 100c having read the data C, the master data is updated by deleting the item regarding the data C from the master data stored in the memory 50. The data C is then sent to the relay server 2b (S213). In the information processing terminals 100a, 100b, the data C is received from the relay server 2b (S214). The master data is updated by deleting the item regarding the data C from the master data in the memory 50 (S215 and S216).

Moreover, in the information processing terminal 100c having read the data C, in response to the deletion of the items regarding all the data from the master data, the work completion notice indicting the completion of the reading work is sent to the relay server 2b via the communicator 26 along with delivery destinations (S217). The delivery destinations of the work completion notice are the other information processing terminals 100a, 100b and the master server 2a. The relay server 2b delivers the work completion notice received from the information processing terminal 100c to the information processing terminals 100a, 100b and the master server 2a (S218). The information processing terminals 100a, 100b having received the work completion notice know that all the specified data has been read (S219, S220). As seen from the above, even though the master data is used in place of the number-of-jobs notice, it is possible to reduce an increase in the access load to the relay server 2b as in the case where the number-of-jobs notice is to be received. It is also possible to reduce a decrease in working efficiency due to the access load.

It should be noted that the relay server 2b and the master server 2a are not necessarily implemented as separate server devices as described above. These servers may be implemented by different functions (for example, applications) in a single server. Moreover, the master server 2a may periodically deliver the status of data acquisition known by the master server 2a to each of the information processing terminals 100 via the relay server 2b. Each of the information processing terminals 100 may explicitly show the received status of data acquisition to the worker sequentially or at a predetermined timing by an indication on the display 23, or the like.

### Third Embodiment

Next, an information processing terminal and a data management system according to a third embodiment of the present disclosure will be described with reference to the drawings. The third embodiment is different from the above-described first and second embodiments mainly in that a data update event described in the above-described first embodiment is used and the data update event acquired by an information processing terminal is to be received by another information processing terminal via a relay server and stored in a memory. Components substantially the same as those in the first and second embodiments are denoted by the same reference signs, and the descriptions thereof are omitted.

In the present embodiment, a memory of an information processing terminal not only records data acquired by the information processing terminal but also stores data acquired by another information processing terminal and received via a relay server. Moreover, processing of the data update event capturer 55 and processing of the message communicator 56 are to be managed by not the app 51 but the OS 52. In the processing of the data update event capturer 55, a message associated with a data update event captured by the data update event capturer 55 is stored in the message queue 54. In the processing of the message communicator 56, the message communicator 56 sends the above-described message from the message queue 54 and receives a message from other information processing terminal while a communication with the relay server 2b is possible. Thereby, a data synchronization with the server 2 is performed.

That is to say, the information processing terminal 10 having the function described in the first embodiment use the relay server 2b of the data management system la described in the second embodiment. The relay server 2b, which is able to communicate with each of the plurality of information processing terminals 10 and the server 2, includes the controller 3 and the communicator 5. The controller 3 and the communicator 5 function as a data deliverer that delivers a message associated with a data update event received from the information processing terminal 10 in accordance with a delivery destination specified by the information processing terminal 10.

Thus, in the present embodiment, the app 51 is also able to perform the same logic processing irrespective of the status of the communication with the server 2 and the relay server 2b as in the above-described first embodiment. Moreover, a description on processing to communicate with the server 2 in the program of the app 51 becomes unnecessary. The running of the application cooperative with the server 2 is thus continuable even though the information processing terminal 10 is in a state where a connection to the server 2 and the relay server 2b is not possible. The information processing terminal 10 capable of construction of an application unrestricted by the status of communication is implementable even though the amount of usable computer resources is small. Moreover, in the present embodiment, each of the plurality of information processing terminals 10 is also able to easily know the overall status of data acquisition using the plurality of information processing terminals 10 as in the above-described second embodiment. As a result, even in a case where the individual information processing terminals 10 separately acquire data, it is possible to reduce duplication of data acquisition. That is to say, an improvement in working efficiency can be achieved.

It should be noted that when a data update event is captured, the data update event capturer 55 causes the message queue 54 to store no message associated with the captured data update event in a case where a message associated with a data update event regarding the same data is already stored in the message queue 54.

### Fourth Embodiment

Next, an information processing terminal and a data management system according to a fourth embodiment of the present disclosure will be described with reference to the drawings. The fourth embodiment is different from the above-described second and third embodiments mainly in that the information processing terminal 100 issues a predetermined request to the relay server 2b to receive data from relay server 2b. Components substantially the same as those in the second and third embodiments are denoted by the same reference signs, and the descriptions thereof are omitted.

In the present embodiment, the information processing terminal 100 issues the predetermined request to the relay server 2b. In the data delivery processing performed by the relay server 2b, in a case where there is data whose delivery destination is the information processing terminal 100 having issued the predetermined request, that data is delivered (i.e., sent) to the information processing terminal 100.

This makes it possible to adjust a timing of receiving data acquired by another information processing terminal 100 using the above-described predetermined request. That is to say, it becomes possible to receive data synchronized with a sequence of the processing in the information processing terminal 100. As seen from the above, it is possible to automatically provide data consistency across the plurality of information processing terminals 100, so that on-duty hours of the worker, or the like are reduced and the working efficiency is improved.

In the relay server 2b, data received from each of the information processing terminals 100 is accumulated in the storage 4, which functions as a data accumulator, until the reception of the predetermined request. In a case where data whose delivery destination is the information processing terminal 100 having issued the predetermined request is accumulated in the storage 4, that data is delivered to the information processing terminal 100 having issued the above-described predetermined request through the data delivery process.

Specifically, in the relay server 2b, the data A received from the information processing terminal 100a and whose delivery destinations are the information processing terminals 100b, 100c is accumulated in the storage 4. In this accumulated state, the data A accumulated in the storage 4 and whose delivery destination is the information processing terminal 100b is sent to the information processing terminal 100b in response to the reception of the above-described predetermined request from the information processing terminal 100b. Moreover, in the above-described accumulated state, the data A accumulated in the storage 4 and whose delivery destination is the information processing terminal 100c is sent to the information processing terminal 100c in response to the reception of the above-described predetermined request from the information processing terminal 100c.

This enables the information processing terminal 100 to receive data addressed thereto from the relay server 2b at a timing when the information processing terminal 100 becomes able to issue the predetermined request. For example, in a case where the communication with relay server 2b is impossible, the information processing terminal 100 may be able to receive the data addressed thereto at a timing when becoming able to send the predetermined request. Moreover, in a case where a timing to receive the data addressed to itself is delayed due to processing higher in priority than the reception process, the information processing terminal 100 is able to receive the data at a timing desirable for internal processing by delaying sending the predetermined request in accordance with the delay.

### Fifth Embodiment

Next, an information processing terminal and a data management system according to a fifth embodiment of the present disclosure will be described with reference to the drawings. The fifth embodiment is different from the above-described fourth embodiment mainly in that in a state where the communication with the relay server 2b is impossible, the information processing terminal 100 stores read data as sending-standby data. Components substantially the same as those in the fourth embodiment are denoted by the same reference signs, and the descriptions thereof are omitted.

An information processing terminal connects to a relay server as described above. However, in a case where the information processing terminal enters an uncommunicable state due to connection failure to the relay server, it may be difficult to continue the reading process. In particular, the information processing terminal used in an environment such as a factory or a warehouse where it is difficult to fully provide radio waves for wireless communication is likely to be unable to communicate with the relay server. Thus, it may be difficult to continue the reading process.

In the present embodiment, in the data management processing performed by the controller 21 of the information processing terminal 100, data acquired by reading by the wireless tag processing unit 30 is stored in the memory 50 as sending-standby data in a case where a communication with the relay server 2b is impossible during. When the communication with the relay server 2b becomes possible, the predetermined request is sent. The data is received from the relay server 2b as a response to the predetermined request. Then, among the sending-standby data stored in the memory 50, data unreceived as the response to the predetermined request is sent to the relay server 2b in the data sending processing performed by the controller 21. It should be noted that a management application is installed in the relay server 2b, the management application being for maintaining, until the communication is restored, data whose delivery destination is the information processing terminal 100 which is unable to communicate.

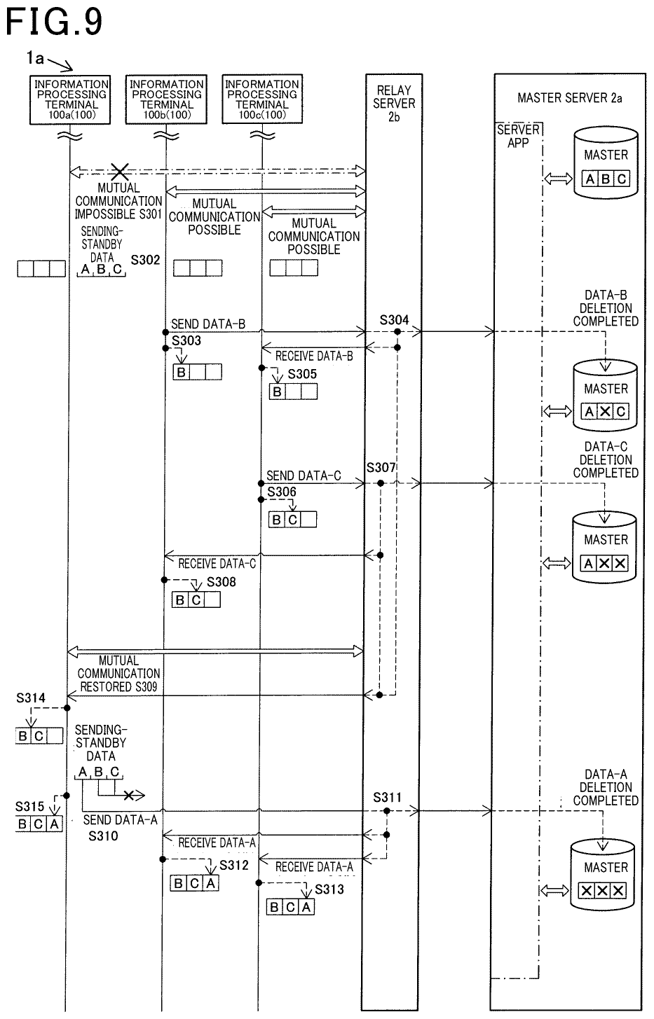

Specifically, out of the information processing terminals 100a, 100b, 100c, only the information processing terminal 100a is unable to communicate with the relay server 2b (S301) as exemplified in FIG. 9. The data A, the data B, and the data C read by the information processing terminal 100a are stored as sending-standby data in the memory 50 (S302).

The data B read by the information processing terminal 100b is sent to the relay server 2b (S303). In the relay server 2b, the received data B is delivered to the information processing terminal 100c and the master server 2a and stored in the storage 4 (S304). A delivery destination of the stored data B is the information processing terminal 100a. In the information processing terminal 100c, the data B received from the relay server 2b is stored in the memory 50 (S305). The data C read by the information processing terminal 100c is then sent to the relay server 2b (S306). In the relay server 2b, the received data C is delivered to the information processing terminal 100b and the master server 2a and stored in the storage 4 (S307). A delivery destination of the stored data C is the information processing terminal 100a. In the information processing terminal 100b, the data C received from the relay server 2b is stored in the memory 50 (S308).

After that, the information processing terminal 100a having become able to communicate with the relay server 2b sends the above-described predetermined request to the relay server 2b before sending the sending-standby data. In response to this, the data B and the data C stored in the storage 4 and whose delivery destination is the information processing terminal 100a is received (S309). Then, among the sending-standby data (i.e., the data A, the data B, and the data C) stored in the memory 50, the data A, which is unreceived as the response to the predetermined request, is sent to the relay server 2b (S310). Neither the data B nor the data C is sent.

The relay server 2b delivers the data A received from the information processing terminal 100a to the information processing terminals 100b, 100c and the master server 2a (S311). In the information processing terminal 100b, the data A received from the relay server 2b is stored in the memory 50 (S312). In the information processing terminal 100c, the data A received from the relay server 2b is stored in the memory 50 (S313).

Moreover, in the above-described data management processing of the information processing terminal 100a, the data received as the response to the predetermined request is stored as data acquired by reading in the memory 50 (S314). Then, among the sending-standby data, the data unreceived as the response to the predetermined request is stored as data acquired by reading in the memory 50 (S315).

As seen from the above, among the sending-standby data acquired while a communication with the relay server 2b is impossible, the data that has not yet delivered through the relay server 2b is sent from the information processing terminal 100 to the relay server 2b when the communication is restored. Moreover, before the sending-standby data is sent to the relay server 2b, the data delivered from the relay server 2b is excluded from among the sending-standby data. This makes it possible to avoid duplicative delivery of the data having been read by another information processing terminal 100 and delivered.

### Sixth Embodiment

Next, an information processing terminal and a data management system according to a sixth embodiment of the present disclosure will be described with reference to the drawings. The sixth embodiment is different from the above-described fifth embodiment mainly in that the information processing terminal 100 which is unable to communicate with the relay server 2b directly passes, as shared data, sending-standby data to another information processing terminal 100. Components substantially the same as those in the fifth embodiment are denoted by the same reference signs, and the descriptions thereof are omitted.

In an information processing terminal which is unable to communicate with a relay server due to a malfunction of a wireless communication function, or the like, sending-standby data stored in a memory is not to be used. Moreover, a worker may be unaware of the malfunction of the wireless communication function and not understand that communication is not possible due to a temporary factor such as the information processing terminal being out of range. In this case, if the worker continues the reading work, data which is unable to be sent to the relay server will be read and stored as sending-standby data in the memory. That is to say, the reading work may be wasted.

The information processing terminal 100 according to the present embodiment directly passes, as shared data, sending-standby data stored in the memory 50 to another information processing terminal 100.

Specifically, the controller 21 of the information processing terminal 100 that passes the shared data performs an information code displaying process. In this process, an information code recording data stored as the sending-standby data in the memory 50 is generated and displayed on the screen of the display 23. Meanwhile, the controller 21 of the information processing terminal 100 that receives the shared data performs an information code reading process. In this process, the shared data is directly received by optically reading the above-described information code with the information code reading unit 40. It should be noted that the controller 21 and the display 23, which perform the above-described information code displaying process, may correspond to an example of a data output unit. The controller 21 and the information code reading unit 40, which perform the above-described information code reading process, may correspond to an example of a data acquirer. Moreover, the displaying corresponds to data output and the reading corresponds to data acquisition.

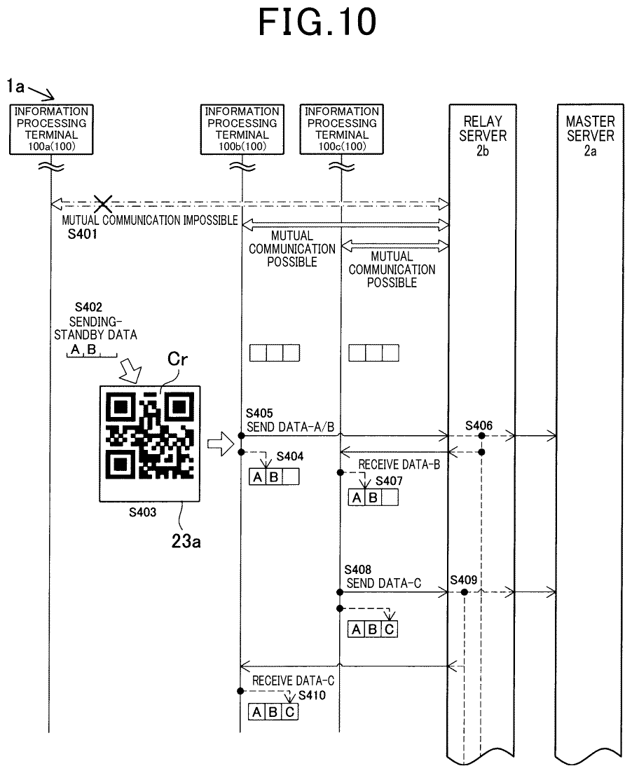

For example, in the information processing terminal 100a which is unable to communicate with the relay server 2b (S401), the data A and the data B may be stored as sending-standby data (S402) as illustrated in FIG. 10. It is assumed that the information processing terminal 100a directly passes the data A and the data B to the information processing terminal 100b. It should be noted that the illustration of the master data in the master server 2a is omitted in FIG. 10 for the purpose of convenience.

In this case, in the information processing terminal 100a, a single information code (for example, a reference sign Cr in FIG. 10) recording the data A and the data B is displayed on a screen 23a of the display 23 in response to a predetermined operation to pass data being performed (S403). Meanwhile, in the information processing terminal 100b, a predetermined receiving operation is performed and the reading aperture 12 is directed at the screen 23a of the information processing terminal 100a. The data A and the data B are then read from the above-described information code by the information code reading unit 40. The read data A and data B are directly received as shared data.

In the controller 21 of the information processing terminal 100b having directly received the data A and the data B as the shared data as described above, neither the data A nor the data B is stored in the memory 50. Accordingly, the data management processing to cause the memory 50 to store the data A and the data B is performed (S404). That is to say, the data management processing causes, among the received shared data, data that has not yet been stored in the memory 50 to be stored in the memory 50. Then, the data A and the data B are sent to the relay server 2b via the communicator 26 along with delivery destinations thereof through the data sending processing performed by the controller 21 (S405). The delivery destinations of the data A and the data B are the other information processing terminals 100a, 100c and the master server 2a.

The relay server 2b delivers the data A and the data B received from the information processing terminal 100b to the information processing terminal 100c and the master server 2a (S406). The data A and the data B whose delivery destination is the information processing terminal 100a are stored in the storage 4.

In a case where the data A and the data B received from the relay server 2b via the communicator 26 are not stored in the memory 50, the controller 21 of the information processing terminal 100c causes the memory 50 to store the data A and the data B (S407).

In the information processing terminal 100c, the data C has been read from the wireless tag T by the wireless tag processing unit 30. Since data C is not stored in the memory 50, the controller 21 of the information processing terminal 100c causes the notification unit 25 to make the predetermined notification. The controller 21 then causes the memory 50 to store the data C. The data C is sent to the relay server 2b via the communicator 26 along with delivery destinations thereof (S408). The delivery destinations of the data C are the other information processing terminals 100a, 100b and the master server 2a.

The relay server 2b delivers the data C received from the information processing terminal 100c to the information processing terminal 100b and the master server 2a (S409). The data C whose delivery destination is the information processing terminal 100a is stored in the storage 4.

In a case where data C received from the relay server 2b is not stored in the memory 50, the controller 21 of the information processing terminal 100b causes the memory 50 to store the data C (S410).

Moreover, in the information processing terminal 100c having read the data C as described above, it is determined that all the data planned to be acquired is stored in the memory 50. The work completion notice is then sent to the relay server 2b via the communicator 26 along with delivery destinations thereof. The delivery destinations of the work completion notice are the other information processing terminals 100a, 100b and the master server 2a. The relay server 2b delivers the work completion notice received from the information processing terminal 100c to the information processing terminal 100b and the master server 2a. The information processing terminal 100b having received the work completion notice knows that all the specified data has been read (i.e., the work completion state).

As seen from the above, it is possible to send, as shared data, the data acquired by the information processing terminal 100a which is unable to communicate with the relay server 2b to the relay server 2b via the information processing terminal 100b which is able to communicate with the relay server 2b. This makes it possible to recover the work even though the communication function of the information processing terminal 100 malfunctions during the data acquisition work.

In particular, in the present embodiment, the information processing terminal 100 which is unable to communicate displays the information code (for example, the reference sign Cr in FIG. 10) recording the shared data. Meanwhile, the information processing terminal 100 which is able to communicate receives the shared data by optically reading the data recorded in the displayed information code.

This enables the information processing terminal 100 which is unable to communicate with not only the relay server 2b but also another information processing terminal 100 to directly pass the shared data to the other information processing terminal 100. In particular, the information code reading unit 40, which is usable to read data, can be used as a data taker for shared data, which makes it possible to smoothly pass and receive the shared data.

It should be noted that in a case where a plurality of pieces of data are stored as sending-standby data in the memory 50, the information processing terminal 100 that passes the data may sequentially display respective information codes recording the plurality of pieces of data at a regular interval. The information processing terminal 100 that receives the data is able to directly receive the plurality of pieces of data by sequentially reading the respective information codes. Moreover, a plurality of pieces of data as sending-standby data (i.e., shared data) may be recorded in a signal information code. Further, a plurality of pieces of data as sending-standby data may be divided into groups and the data of each group may be recorded in a signal information code. For example, it may be assumed that eight pieces of data are divided into three groups, which are a group of three of them, a group of another three of them, and a group of two of them. In this case, an information code recording the three pieces of data of the first group, an information code recording the three pieces of data of the next group, and an information code recording the two pieces of data of the last group may be sequentially displayed.

Moreover, a means for passing and receiving shared data is not necessarily reading of the information code described above. For example, a wireless communication using the near field wireless communicator 27 or Wi-Fi, a wire communication using a cable, or the like may be used as the data output unit and the data acquirer for passing and receiving shared data.

### Seventh Embodiment

Next, an information processing terminal and a management system according to a seventh embodiment of the present disclosure will be described with reference to the drawings.

As a conventional scheme to control an information processing terminal using a thin client system, a screen transfer type scheme is provided, in which drawing information regarding an entire screen to be displayed is to be sent from a server to the information processing terminal. For the screen transfer type, a screen rewriting response may be delayed depending on a network communication state. Meanwhile, as another scheme, a network booting type scheme usable even offline is provided. For the network booting type, when an application to perform complicated processing runs in a portable information processing terminal, a processing time may be increased. One reason for the above is that a portable information processing terminal usually has a small amount of computer resources.

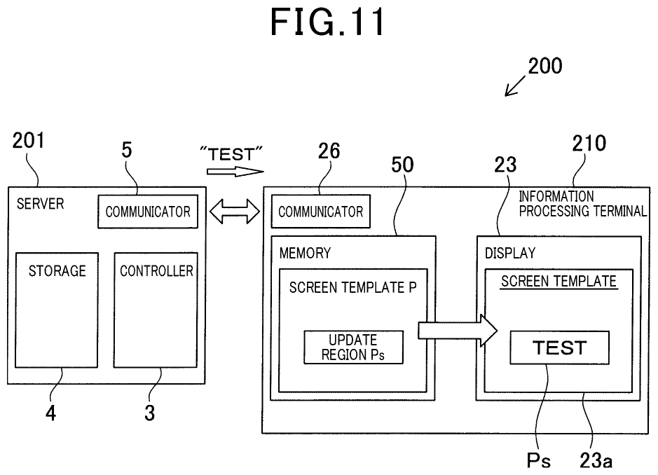

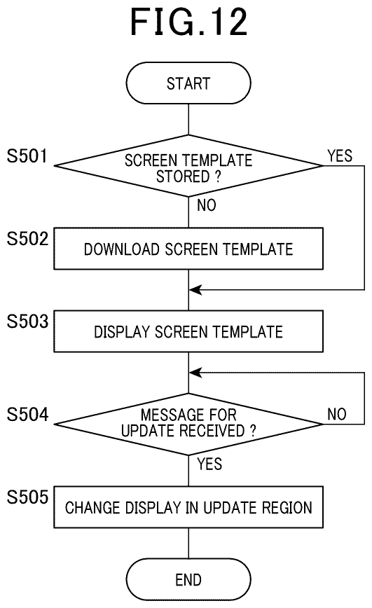

In a management system 200 including an information processing terminal 210 and a server 201 according to the present embodiment, a screen template P provided with an update region Ps is stored in advance in the memory 50 of the information processing terminal 210 as exemplified in FIG. 11. The screen template P may be downloaded. This reduces the amount of drawing information used for the display of the screen 23a of the display 23 when executing the predetermined application. The drawing information is to be transferred from the server 201 via the communicator 26. This improves a response of screen update (i.e., screen rewriting). It should be noted that a hardware configuration of the information processing terminal 210 is substantially the same as the hardware configuration of the above-described information processing terminal 10 or information processing terminal 100. A hardware configuration of the server 201 is also substantially the same as the hardware configuration of the above-described server 2.

Specifically, the predetermined application is executed by the controller 21 as in a flowchart illustrated in FIG. 12. At this time, in a case where screen template P is not stored in advance (No in S501), a first request regarding a screen template is sent to the server 201 via the communicator 26. The screen template P is, as a response to the first request, downloaded from the server 201 and stored in the memory 50 (S502). In a case where the screen template P is to be downloaded or already stored in the memory 50 (Yes in S501), the screen template P is read from the memory 50 and displayed on the screen 23a of the display 23 (S503). In a case where no message for update of the screen is received from the server 201 via the communicator 26 (No in S504), the update region Ps of the screen template P is blank. A second request regarding a message for update is sent to the server 201 via the communicator 26. In response to the message for update being received from the server 201 as a response to the second request (Yes in S504), information based on the message for update is displayed in the update region Ps of the screen template P (S505).

In an example in FIG. 11, in executing the predetermined application, the screen template P of the screen 23a is updated on the basis of TEST contained in the message for update received, as the response to the second request, from the server 201. As a result, the TEST is displayed in the update region Ps.

The information processing terminal 210 according to the present embodiment is provided in the management system 200 including the server 201, the information processing terminal 210 including:
the controller 21 for executing the predetermined application;
the communicator 26 for sending a message to the server 201 and receiving a message from the server 201;
the display 23; and
the memory 50 that stores the screen template P that is to be displayed on the screen 23a of the display 23 in executing the predetermined application;
in which
the predetermined application updates, on the basis of the message received from the server 201 via the communicator 26, the update region Ps of the screen template P read from the memory 50 in executing the predetermined application.

As seen from the above, the server 201 sends, as the message for update, an instruction on an update of a portion of a screen to be displayed in the information processing terminal 210. This makes it possible to update the screen at a higher speed than a conventional screen-transfer type thin client system. Then, in the information processing terminal 210, the screen template P is stored in advance in the memory 50. The application thus generates only the portion of the screen, which makes it possible to perform fast the screen displaying process. In other words, only the update region Ps, which is the portion of the screen, is updated instead of the whole of the screen being updated, which makes it possible to perform fast the screen displaying process.

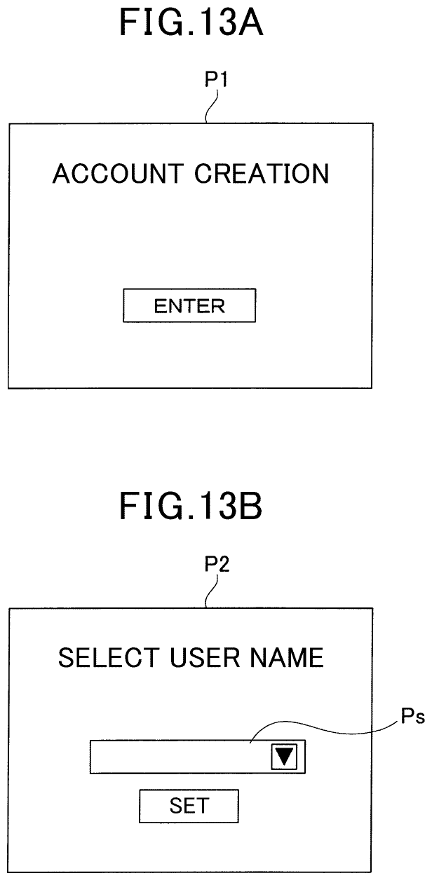

It should be noted that the memory 50 does not necessarily store the single screen template P and may store a plurality of types of screen templates P usable by the predetermined application. Moreover, the displayed screen template P may be switched in accordance with an operation on the operating unit 24, or the like. For example, a first screen template P1 exemplified in FIG. 13A may be displayed. Then, as an Enter key of the operating unit 24 is pressed, a second screen template P2 illustrated in FIG. 13B is displayed. A pulldown menu is arranged in the update region Ps of the second screen template P2. The content of the pulldown menu is received as the response to the above-described second request from the server 201. It should be noted that an image ENTER displayed on the screen of the display 23 in a form of a touch panel may be tapped in place of the ENTER key of the operating unit 24 being pressed.

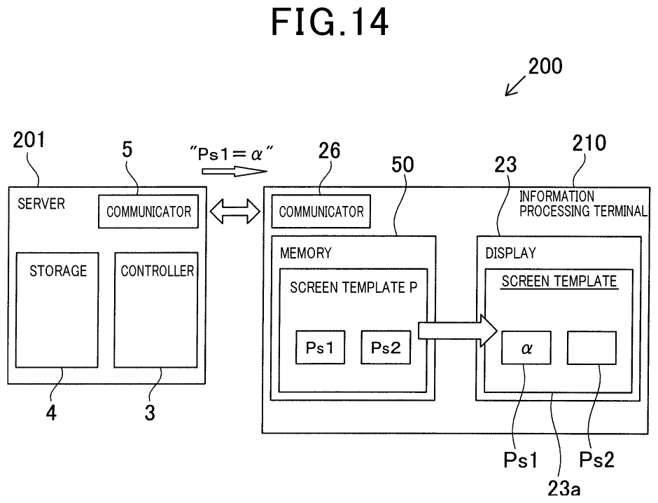

Next, a first modification example of the seventh embodiment will be described with reference to FIG. 12 and FIG. 14. In the first modification example of the seventh embodiment, a plurality of update regions Ps are provided in the single screen template P. Accordingly, a message for update received from the server 201 in accordance with the second request contains position information for specifying respective positions of the plurality of update regions Ps.

Specifically, the screen template P having two first update region Ps1 and second update region Ps2 is assumed as illustrated in FIG. 14. The above-described screen template P is downloaded and stored in the memory 50 (S502). In response to a message for update being received from the server 201 as a response to the second request for updating the first update region Ps1 (Yes in S504), information based on the message for update is displayed in the first update region Ps1 of the screen template P (S505). In an example in FIG. 14, the screen template P of the screen 23a is updated on the basis of α and the position information, which indicates the position of the first update region Ps1. The message for update received from the server 201 contains a and the position information. As a result, α is displayed in the first update region Ps1. Likewise, in response to a message for update being received from the server 201 as a response to the second request for updating the second update region Ps2 (Yes in S504), information based on the message for update is displayed in the second update region Ps2 of the screen template P (S505).

As seen from the above, the plurality of update regions Ps are provided in the single screen template P. Moreover, a message for update received from the server 201 contains position information for specifying the positions of the update regions Ps. This makes it possible to update the plurality of update regions Ps on the screen template P in accordance with the message for update from the server 201.

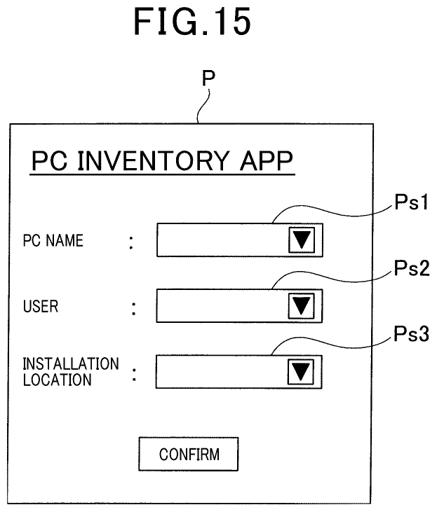

The number of the update regions Ps is not limited to two with respect to the single screen template P as described above and may be three or more. For example, the screen template P may be provided with the first update region Ps1 where a pulldown menu of the PC (personal computer) name is displayed, the second update region Ps2 where a pulldown menu of the user is displayed, and a third update region Ps3 where a pulldown menu of the installation location is displayed as exemplified in FIG. 15. In this case, the content of the pulldown menu in the first update region Ps1 is to be received from the server 201 in accordance with the second request corresponding to an operation of the pulldown menu in the first update region Ps1. Moreover, the content of the pulldown menu in the second update region Ps2 is to be received from the server 201 in accordance with the second request corresponding to an operation of the pulldown menu in the second update region Ps2. The content of the pulldown menu in the third update region Ps3 is to be received from the server 201 in accordance with the second request corresponding to an operation of the pulldown menu in the third update region Ps3.

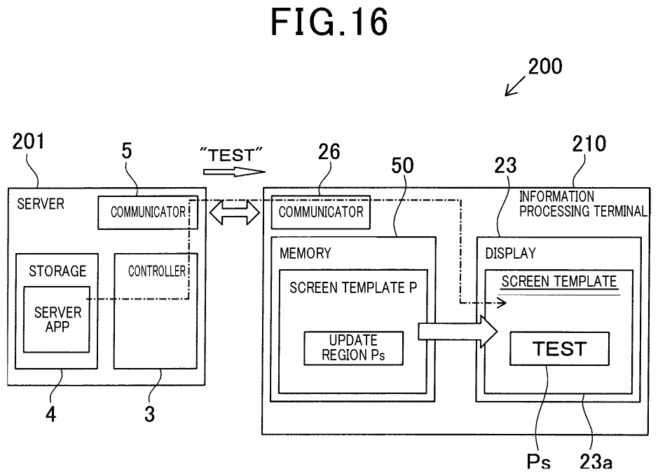

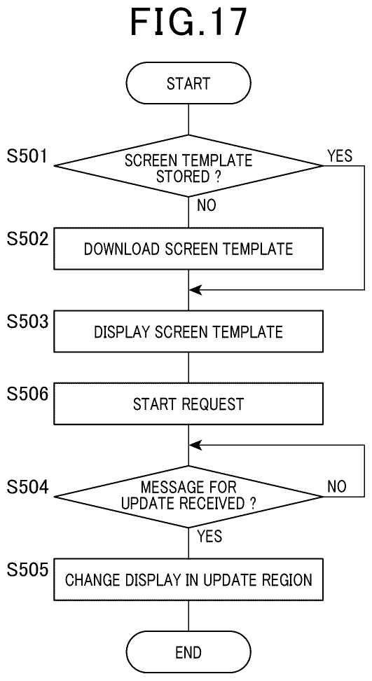

Next, a second modification example of the seventh embodiment will be described with reference to FIG. 16 and FIG. 17. In the second modification example of the seventh embodiment, the processing to update the screen is to be performed by a server application for screen update in the server 201 in place of the application in the information processing terminal 210 as exemplified in FIG. 16. A message for update regarding the update region Ps is thus sent from the server 201 to the information processing terminal 210.

Specifically, in the information processing terminal 210, the screen template P read from the memory 50 is displayed on the screen 23a (S503) as illustrated in a flowchart in FIG. 17. A start request for the server application for screen update is sent to the server 201 via the communicator 26 (S506). In response to the start request, the server application for screen update is started in the server 201. The server application started in the server 201 performs processing to update the screen. As a result of the processing of the server application, a message for update is received from the server 201 (Yes in S504). Information based on the message for update is displayed in the update region Ps of the screen template P (S505).

This makes it possible to update the screen (i.e., rewrite the screen) at a higher speed than in a case where processing for updating the screen is performed through the application of the information processing terminal 100 (i.e., the terminal application), even though the processing for updating the screen is complicated. One reason for the above is that the server 201 has a larger amount of computer resources than the information processing terminal 210.

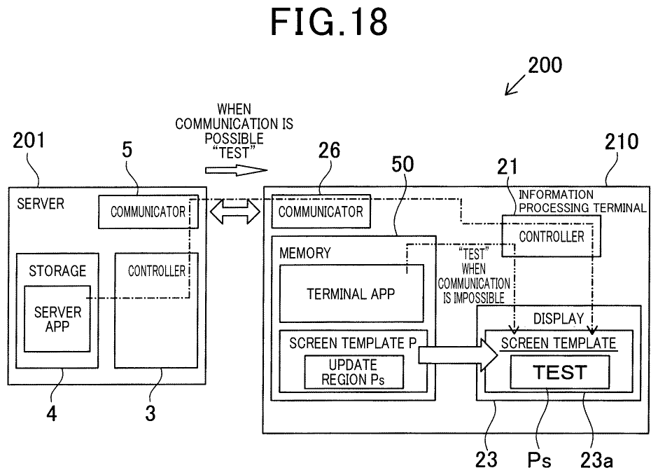

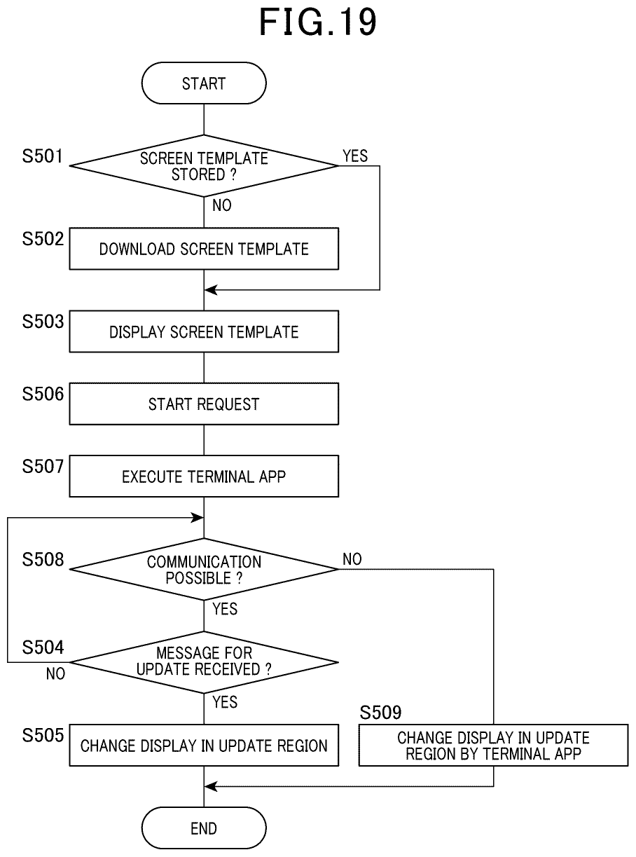

Next, a third modification example of the seventh embodiment will be described with reference to FIG. 18 and FIG. 19. In the third modification example of the seventh embodiment, an application for screen update is to be switched on the basis of whether the information processing terminal 210 is a network-communicable state (i.e., the information processing terminal 210 is a state where a communication with the server 201 is possible) as exemplified in FIG. 18.

Specifically, in the information processing terminal 210, the screen template P read from the memory 50 is displayed on the screen 23a (S503) as illustrated in a flowchart in FIG. 19. A start request for the server application for screen update is sent to the server 201 via the communicator 26 (S506). In the information processing terminal 210, a terminal application for screen update is executed (S507). Thus, in the network-communicable state, the terminal application for screen update and the server application for screen update are executed in parallel.

In a case where the information processing terminal 210 is in the network-communicable state (Yes in S508), a message for update is received from the server 201 in accordance with the second request (Yes in S504). Information based on the message for update is displayed in the update region Ps of the screen template P (S505). In contrast, in a case where the information processing terminal 210 is not in the network-communicable state (No in S508), the information displayed in the update region Ps of the screen template P is changed (i.e., updated) on the basis of an execution result of the terminal application for screen update (S509).

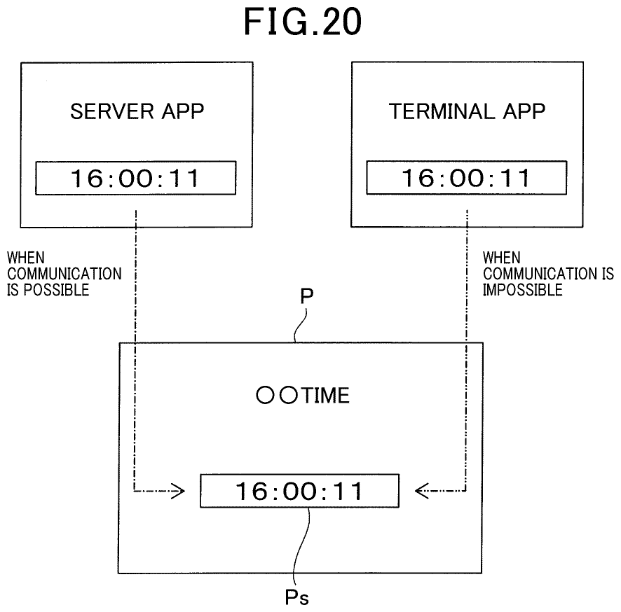

For example, it may be assumed that the application for screen update is an application for displaying time as exemplified in FIG. 20. In a case where the information processing terminal 210 is in the network-communicable state, a message for update regarding time information obtained by the execution of the server application is received (Yes in S504). The time information is then displayed in the update region Ps of the screen template P (S505). In contrast, in a case where the information processing terminal 210 is not in the network-communicable state, the time information obtained by the execution of the terminal application is displayed in the update region Ps of the screen template P (S509).

Therefore, a screen update can be performed at a high speed using the computer resources of the server 201 in the network-communicable state. The screen update can be continuable using the terminal application executed by the information processing terminal 210 in the network-uncommunicable state.

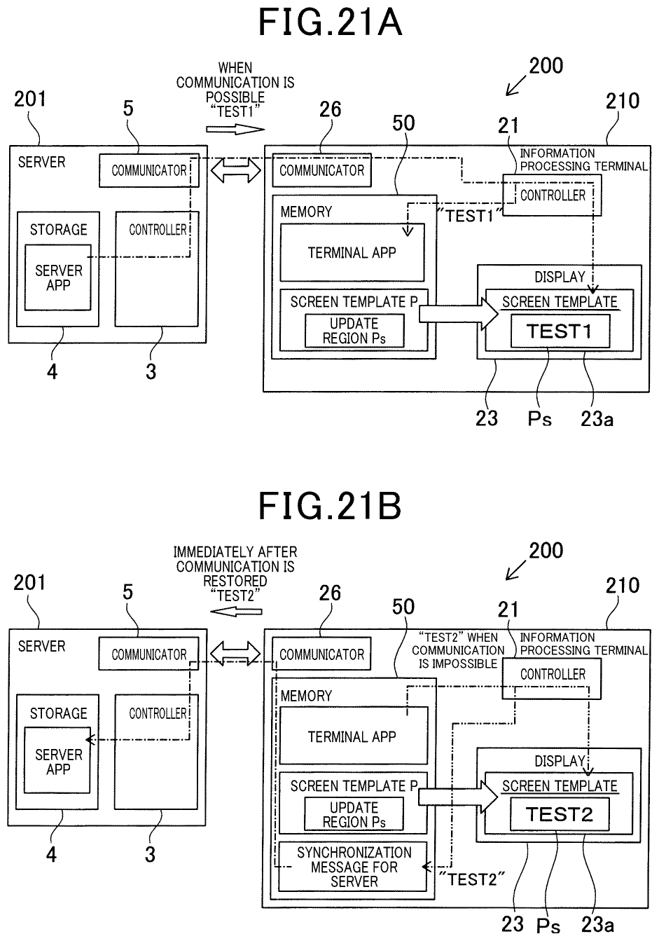

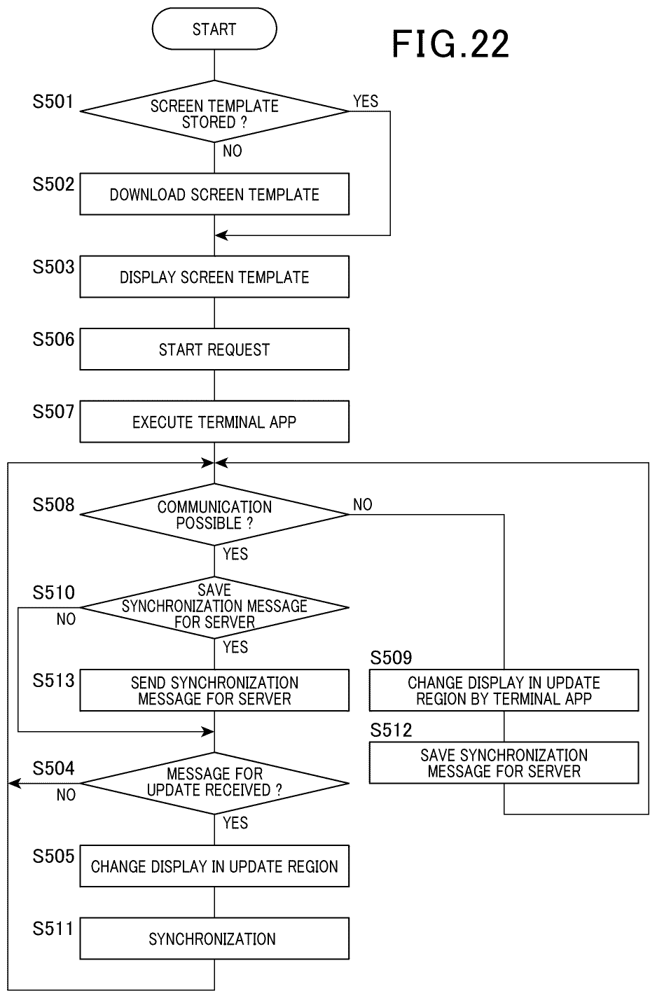

Next, a fourth modification example of the seventh embodiment will be described with reference to FIG. 21 and FIG. 22. In the fourth modification example of the seventh embodiment, the displayed content of the terminal application is to be synchronized with the displayed content updated by the server application in the network-communicable state. Moreover, the displayed content of the server application is to be synchronized with the displayed content updated by the terminal application in the network-uncommunicable state after a transition to the network-communicable state.

As illustrated in FIG. 21A, in a case where the displayed content is updated by the server application in the network-communicable state, a message for synchronizing the displayed content with the terminal application (hereinafter, also referred to as a synchronization message for the terminal) is sent from the server 201 to the information processing terminal 210. Moreover, as illustrated in FIG. 21B, in a case where the displayed content is updated by the terminal application in the network-uncommunicable state, a message for synchronizing the displayed content with the server application (hereinafter, also referred to as a synchronization message for the server) is stored in the memory 50. The synchronization message for the server is then sent from the information processing terminal 210 to the server 201 when the communication is restored.

Specifically, the terminal application for screen update and the server application for screen update are executed in parallel in the information processing terminal 210 (S506 and S507) as illustrated in a flowchart in FIG. 22. In a case where the information processing terminal 210 is the network-communicable state (Yes in S508), it is determined whether the synchronization message for the server is stored in the memory 50 (S510).

In a case where no synchronization message for the server is stored in the memory 50 (No in S510) and a message for update is received from the server 201 (Yes in S504), the information based on the message for update is displayed in the update region Ps of the screen template P (S505). The terminal application performs processing to be synchronized with the server application executed in parallel using the synchronization message for the terminal received as the message for update from the server 201 (S511).

In a case where the information processing terminal 210 is in the network-uncommunicable state (No in S508), the information displayed in the update region Ps of the screen template P is changed (i.e., updated) on the basis of an execution result of the terminal application for screen update (S509). Then, a synchronization message for the server corresponding to the display update is generated and stored in the memory 50 (S512). The screen update is performed by the terminal application until the information processing terminal 210 is restored to the network-communicable state. For each screen update, a synchronization message for the server corresponding to the screen update is generated and stored in the memory 50.

In response to the information processing terminal 210 being restored to the network-communicable state (Yes in S508), the stored synchronization message for the server is sent to the server 201 via the communicator 26 (S513), since the synchronization message for the server is stored in the memory 50 (Yes in S510). Thus, the server application in the server 201 performs processing to be synchronized with the terminal application executed in parallel using the synchronization message for the server received from the information processing terminal 210.

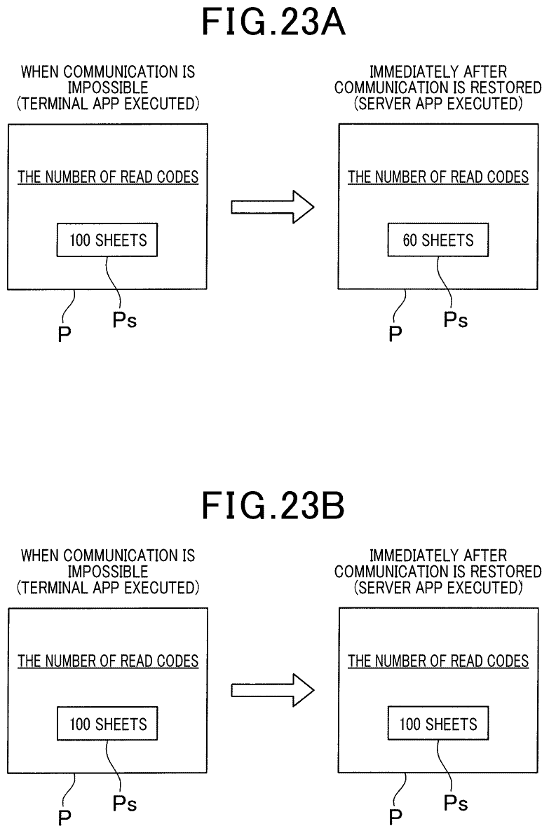

For example, an application to display the number of information codes read by the formation processing terminal 210 may be assumed. In a case where the synchronization processing as described above is not performed, 60 sheets of information codes are first read in the network-communicable state as exemplified in FIG. 23A. Next, another 40 sheets of information codes are further read in the network-uncommunicable state and “100 SHEETS” is displayed as the number of the read information codes. After that, when the communication is restored, an incorrect number, “60 SHEETS”, is displayed as the number of the read information codes. One reason for the above is that non-updated information from the server application is displayed.

However, the above-described event is avoided by performing the synchronization processing as in the present modification example. It is assumed that 60 sheets of information codes are to be read in the network-communicable state and then another 40 sheets of information codes are further read in the network-uncommunicable state as described above. In the present modification example, a synchronization message for the server indicating the number of the additionally read information codes, 40 sheets, is sent from the information processing terminal 210 to the server 201. This enables the server application to be synchronized with the terminal application in terms of the number of the read information codes using the synchronization message for the server. As a result, a correct number “100 SHEETS” is displayed as the number of the read information codes when the communication is restored as exemplified in FIG. 23B.

As seen from the above, the displayed content of the terminal application is synchronized with the displayed content updated by the server application in the network-communicable state and the displayed content of the server application is synchronized with the displayed content updated by the terminal application in the network-uncommunicable state. This makes it possible to correctly and effectively use a result of a work performed in the network-uncommunicable state.

It should be noted that the present disclosure is not limited to the above-described embodiments and the like and may be modified, for example, as below.

(1) In the present disclosure, data to be acquired by the information processing terminals 10, 100, 210 reading is not limited to a tag ID recorded in the wireless tag T. The data to be acquired may be information recorded in an information code or information recorded in a plurality of types of media such as the wireless tag T and an information code. Moreover, the present disclosure is not limited to being applied to an information processing terminal, a server, and the like used for the inventory work. The present disclosure may be applied to an information processing terminal, a server, and the like used for another work involving data acquisition.

It should be noted that the technical features included in the above-described embodiments may be expressed as the following features. The present disclosure is, of course, not limited to the following features.

### Feature 1

A data management system including:
a plurality of information processing terminals; and
a relay server configured to communicate with the plurality of information processing terminals, in which
each of the plurality of information processing terminals includes:
an acquirer configured to acquire data;
a storage configured to store the data acquired by the acquirer;
a data sender configured to send the data acquired by the acquirer to the relay server along with a delivery destination;
a data receiver configured to receive data delivered from the relay server; and
a data manager configured to cause the storage to store, among the data received by the data receiver, data that has not yet been stored in the storage,
the delivery destination includes at least one of the plurality of information processing terminals other than the each of the plurality of information processing terminals, and
the relay server includes
a data deliverer configured to deliver the data received from the each of the plurality of information processing terminals to the delivery destination.

### Feature 2

The data management system according to Feature 1, in which
in the each of the plurality of information processing terminals, the data sender is configured to send, among the data acquired by the acquirer, data that has not yet been stored in the storage to the relay server.

### Feature 3

The data management system according to Feature 2, in which
the each of the plurality of information processing terminals is configured to send a predetermined request to the relay server, and
in a case where first data is received and a delivery destination of the first data is the each of the plurality of information processing terminals having sent the predetermined request, the data deliverer is configured to deliver the first data to the each of the plurality of information processing terminals having sent the predetermined request.

### Feature 4

The data management system according to Feature 3, in which
the relay server includes a data accumulator configured to accumulate data received from the each of the plurality of information processing terminals, and
in a case where the first data is accumulated in the data accumulator, the data deliverer is configured to deliver the first data to the each of the plurality of information processing terminals having sent the predetermined request.

### Feature 5

The data management system according to Feature 4, in which
in the each of the plurality of information processing terminals,
in a case where the each of the plurality of information processing terminals is in a state where a communication with the relay server is impossible, the data manager is configured to cause the storage to store, as sending-standby data, the data acquired by the acquirer, and
in a case where the each of the plurality of information processing terminals is in a state where a communication with the relay server is possible, in response to the data receiver receiving the data as a response to the predetermined request, the data sender is configured to send, among the sending-standby data stored in the storage, data that has not yet been received as the response to the redetermined request to the relay server.

### Feature 6

The data management system according to Feature 1, in which
in the each of the plurality of information processing terminals, the data sender is configured to send, in response to the data manager determining that all of data planned to be acquired is stored in the storage, a work completion notice to the relay server along with a delivery destination, and
the delivery destination of the work completion notice includes at least one of the plurality of information processing terminals other than the each of the plurality of information processing terminals.

### Feature 7

The data management system according to Feature 1, in which
the each of the plurality of information processing terminals includes:
a data output unit configured to output, as shared data, the data stored in the storage for at least one of the plurality of information processing terminals other than the each of the plurality of information processing terminals; and
a data acquirer configured to acquire the shared data outputted from the data output unit of the at least one of the plurality of information processing terminals other than the each of the plurality of information processing terminals, and
in the each of the plurality of information processing terminals, the data manager is configured to cause the storage to store, among the shared data acquired by the data acquirer, data that has not yet been stored in the storage.

### Feature 8)

The data management system according to Feature 7, in which
in the each of the plurality of information processing terminals, the data output unit is configured to display a single information code recording the shared data or display a plurality of information codes recording respective portions of the shared data, and
the data acquirer is configured to acquire the shared data by optically reading the shared data from the single information code or the plurality of information codes.

What is claimed is:

1. An information processing terminal comprising:
a memory;
a processor configured to load programs from the memory to execute the programs; and
a transceiver configured to send a message to a server and receive a message from the server, wherein
the memory is configured to store:
a program of a predetermined application;
a program of an operating system configured to manage the predetermined application;
data obtained by execution of the predetermined application;
a message queue; and
a program of a first processing unit and a second processing unit,
the predetermined application, the operating system, the first processing unit, and the second processing unit are implemented by the processor executing the programs stored in the memory,
the first processing unit is configured to capture a data update event generated by executing the predetermined application and cause the message queue to store a message associated with the data update event,
the second processing unit is configured to perform a data synchronization with the server by sending the message associated with the data update event stored in the message queue to the server when the information processing terminal is able to communicate with the server, and
the predetermined application is configured to run independently of the first processing unit and the second processing unit.

2. The information processing terminal according to claim 1, wherein
the message associated with the data update event includes data update information.

3. The information processing terminal according to claim 1, wherein
the first processing unit is configured to cause the message queue not to store the message associated with the captured data update event when the data update event is captured in a case where the message associated with the data update event regarding same data has already stored in the message queue.

4. A data management system comprising:
a plurality of the information processing terminals according to claim 3; and
a relay server configured to relay a communication between the plurality of information processing terminals and the server, wherein
the relay server is configured to receive the message associated with the data update event from each of the plurality of information processing terminals along with a delivery destination specified by the each of the plurality of information processing terminals and deliver the message associated with the data update event in accordance with the delivery destination.

5. The data management system according to claim 4, wherein
the each of the plurality of information processing terminals is configured to send a predetermined request to the relay server, and
the relay server is configured to:
accumulate the message associated with the data update event received from the each of the plurality of information processing terminals; and
deliver a first message associated with the data update event to the each of the plurality of information processing terminals having sent the predetermined request in a case where the first message associated with the data update event is accumulated and a delivery destination of the first message is the each of the plurality of information processing terminals having sent the predetermined request.

6. The data management system according to claim 4, wherein
the each of the plurality of information processing terminals is configured to send the predetermined request to the relay server after confirming that the each of the plurality of information processing terminals is able to communicate with the relay server.

7. The data management system according to claim 4, wherein
the second processing unit of the each of the plurality of information processing terminals is configured to send a work completion notice to the relay server along with a delivery destination in response to determining that messages associated with the data update event regarding all of data planned to be acquired has been stored in the message queue, and
the delivery destination of the work completion notice includes at least one of the plurality of information processing terminals other than the each of the plurality of information processing terminals.
